(19) United States
(12) Patent Application Publication
(10) Pub. No.: US 2017/0038508 A1
(43) Pub. Date: Feb. 9, 2017

(54) LIGHT REFLECTIVE FILM ROLL AND LIGHT REFLECTIVE FILM ROLL PACKAGE

(71) Applicant: Konica Minolta, Inc., Tokyo (JP)

(72) Inventor: YUKAKO TAKA, Tokyo (JP)

(21) Appl. No.: 15/304,236

(22) PCT Filed: Mar. 20, 2015
(86) PCT No.: PCT/JP2015/058571

§ 371 Date: Oct. 14, 2016

(30) Foreign Application Priority Data
Apr. 17, 2014 (JP) 2014-085798

(51) Int. Cl. G02B 5/28; B65D 85/66; G02B 1/14

(52) U.S. Cl. CPC G02B 5/282; G02B 1/14; B65D 85/66

(57) ABSTRACT

A light reflective film roll may include a core main body formed in a cylindrical shape and having a length in a width direction of 1.2 m or more; a cushion layer formed by a foamed resin and provided on an outer surface of the core main body; and a light reflective film including a light reflective membrane, which has a reflection unit formed by alternately laminating a high refractive index layer and a low refractive index layer, a pressure sensitive adhesive layer at one outermost layer of the light reflective membrane, and a hard coat layer at the other outermost layer of the light reflective membrane. The light reflective film may be wound up on the outer surface of the cushion layer.

### CROSS REFERENCE TO RELATED APPLICATIONS

This is the U.S. national stage of application No. PCT/JP2015/058571, filed on Mar. 20, 2015. Priority under 35 U.S.C. §119(a) and 35 U.S.C. §365(b) is claimed from Japanese Application No. 2014-085798, filed Apr. 17, 2014, the disclosure of which is also incorporated herein by reference.

### TECHNICAL FIELD

The present invention relates to a light reflective film roll and a light reflective film roll package.

### BACKGROUND ART

In recent years, an increased concern for energy saving measures has led to an active development of a near-infrared light reflective film to block the transmission of heat rays in the sunlight entering through the window glass of a building and a vehicle. The reason for this is that this makes it possible to reduce the load on cooling facilities so as to be an effective energy saving measure.

Hitherto, a method is proposed in which light having a specific wavelength (particularly, near-infrared light that is a heat ray in the sunlight) is selectively reflected using, as a near-infrared light reflective film, a light reflective membrane having a reflection unit formed by alternately laminating a high refractive index layer and a low refractive index layer (for example, see Patent Literature 1).

Meanwhile, it is known that, as an image receiving paper roll which is wound up while a flat and smooth state is maintained, a cushion layer and a smoothening layer are provided in a core main body (for example, see Patent Literature 2).

### CITATION LIST

### Patent Literature

Patent Literature 1: JP 2002-509279 A

Patent Literature 2: JP 2011-167929 A

### SUMMARY OF INVENTION

### Technical Problem

In general, a near-infrared light reflective film described in Patent Literature 1 is stored and transported in the form of the light reflective film roll in which the near-infrared light reflective film is wound up on a core main body. Depending on the form of the light reflective film roll, it is found out that, when a necessary amount of the near-infrared light reflective film is taken out and cut from the light reflective film roll and then the cut near-infrared light reflective film is attached to glass (for example, the windshield of an automobile or the window glass of a building) for use, unevenness visually confirmed by irradiation with sunlight occurs. Particularly, it is found out that there is a problem in that, when the length of the core main body in the width direction is 1.2 m or more, unevenness is likely to be visually confirmed particularly with sunlight. The reason for this is speculated as follows. When the light reflective film is wound up on the core main body, a step difference is generated between the surface of the core main body and the winding start end portion of the light reflective film. If the length of the core main body in the width direction is 1.2 m or more, deflection occurs in the light reflective film roll due to the weights of the core main body and the light reflective film when both the ends of the core main body are supported. Due to this deflection, stress is applied to the portion, at which the light reflective film is overlapped on the step difference, of the light reflective film wound up on the core main body, and thus a fine defect is easily generated on the light reflective film.

An object of the present invention is to provide a light reflective film roll that can prevent stress (load) from being applied from the outside to an end portion at which a light reflective film is started to be wound up on a core main body having a length in a width direction of 1.2 m or more or the vicinity thereof, particularly, to a light reflective membrane having a reflection unit formed by alternately laminating a high refractive index layer and a low refractive index layer and that can reduce unevenness confirmed by irradiation with sunlight when a necessary amount of a near-infrared light reflective film is taken out and cut from the light reflective film roll, and then the cut light reflective film is attached to glass, and to provide a package thereof.

### Solution to Problem

In this regard, the present inventors conducted intensive studies in view of the above problems. As a result, they found out that the problem may be solved by employing a core configuration (structure) which can prevent stress (load) from being applied from the outside to a light reflective membrane, which has a reflective unit in which a high refractive index layer and a low refractive index layer are alternately laminated, of a winding start end portion or in the vicinity thereof, and thus the present invention has been completed.

That is, the object of the present invention described above is achieved by the following configuration.

1. A light reflective film roll including:

a core main body formed in a cylindrical shape and having a length in a width direction of 1.2 m or more;

a cushion layer formed by a foamed resin and provided on an outer surface of the core main body; and

a light reflective film including a light reflective membrane, which has a reflection unit formed by alternately laminating a high refractive index layer and a low refractive index layer, a pressure sensitive adhesive layer at one outermost layer of the light reflective membrane, and a hard coat layer at the other outermost layer of the light reflective membrane,

wherein the light reflective film is wound up on the outer surface of the cushion layer.

2. The light reflective film roll according to Item. 1, wherein an end portion at which the light reflective film is started to be wound up is attached to the cushion layer provided on the core main body by a cushion member.

3. The light reflective film roll according to Item. 1 or 2, wherein a winding finish end portion of the light reflective film is taped by a tape at least two positions and the tape positions closest to right and left end portions in the width direction of the light reflective film roll satisfy the following formula:

(Tape position from end portion in width direction of light reflective film roll/length of light reflective film roll in width direction)×100=0.5 to 25% [Mathematical Formula 1]

wherein, regarding the tape position from the end portion in the width direction of the light reflective film roll, the position of the tape closest to the left end portion in the width direction is designated as the tape position from the left end portion, the position of the tape closest to the right end portion in the width direction is designated as the tape position from the right end portion, each tape position satisfies the above requirement, and the tape position is designated as the center portion of the tape width. Herein, the width direction indicates a center line (axis) direction (or an axis direction) of the cylindrical body such as the light reflective film roll or the core main body.

4. A light reflective film roll package including the light reflective film roll according to any one of Items. 1 to 3 in a tubular bag.

### Advantageous Effects of Invention

According to the present invention, regarding the light reflective film roll using the core main body having a length in the width direction of 1.2 m or more, which has a problem in that unevenness is likely to be visually confirmed with sunlight, there is provided a light reflective film roll that can prevent stress (load) from being applied from the outside to a light reflective membrane, which has a reflection unit formed by alternately laminating a high refractive index layer and a low refractive index layer, of a winding start end portion of a light reflective film or in the vicinity thereof and that can reduce unevenness confirmed by irradiation with sunlight.

In addition, according to the present invention, there is provided a light reflective film roll package that can prevent troubles caused by winding misalignment between a hard coat surface at the outermost peripheral surface portion of the light reflective film roll and a package sheet (for example, scratches or fine unevenness on the surface of the light reflective film roll, and folding and bending, turning-up, or loosening of the end portion of the light reflective film).

### BRIEF DESCRIPTION OF DRAWINGS

FIG. 1A is a schematic perspective view schematically illustrating the representative configuration of an optical reflective film roll used in an embodiment of the present invention.

FIG. 1B is a schematic cross-sectional view perpendicular to the axis direction of FIG. 1A.

FIG. 1C is a schematic perspective view schematically illustrating the representative configuration of an optical reflective film roll of a related art.

FIG. 2A is a schematic perspective view schematically illustrating the configuration of a cushion core portion of the optical reflective film roll of FIG. 1A.

FIG. 2B is a partial cross-sectional view perpendicular to the axis direction illustrating a state where an end portion at which a light reflective film is started to be wound up is attached to the core main body of FIG. 1C.

FIG. 3 is a schematic perspective view illustrating the basic configuration of an optical reflective film roll package used in an embodiment of the present invention.

### DESCRIPTION OF EMBODIMENTS

Hereinafter, an embodiment for carrying out an optical reflective film roll of the present invention and a package thereof will be described in detail. However, the technical scope of the present invention should be determined based on the appended claims and not limited only to the embodiments below.

[Light Reflective Film Roll]

A light reflective film roll of this embodiment includes: a core main body formed in a cylindrical shape and having a length in a width direction of 1.2 m or more; a cushion layer formed by a foamed resin and provided on an outer surface of the core main body; and a light reflective film including a light reflecting membrane, which has a reflection unit formed by alternately laminating a high refractive index layer and a low refractive index layer, a pressure sensitive adhesive layer provided on one outermost layer of the light reflective membrane, and a hard coat layer provided on the other outermost layer of the light reflective membrane, and is characterized in that the light reflective film is wound up on the outer surface of the cushion layer. In addition, in the light reflective film roll of this embodiment, it is preferable that an end portion at which the light reflective film is started to be wound up is attached to the cushion layer provided on the core main body by a cushion member.

Incidentally, in the present specification, a refractive index layer having a higher refractive index compared to other is referred to as a high refractive index layer and a refractive index layer having a lower refractive index compared to other is referred to as a low refractive index layer. In the present specification, the terms “high refractive index layer” and “low refractive index layer” mean that when the difference between the refractive indices of two adjacent layers is compared, a refractive index layer having a higher refractive index is designated as the high refractive index layer, and a refractive index layer having a lower refractive index is designated as the low refractive index layer.

Hereinafter, an embodiment for carrying out the present invention will be described in detail with reference to the accompanying drawings. Incidentally, in the description of the drawings, the same reference numerals will be given to the same elements, and duplicate description will be omitted. In addition, the dimension ratios of the drawings include some exaggeration for descriptive reasons, and may thus be different from the actual ratios.

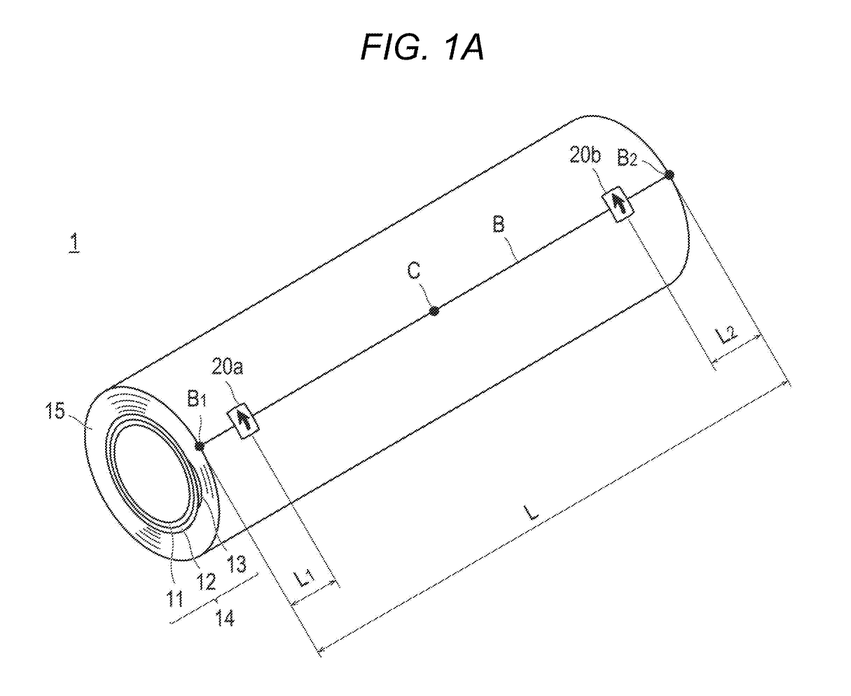

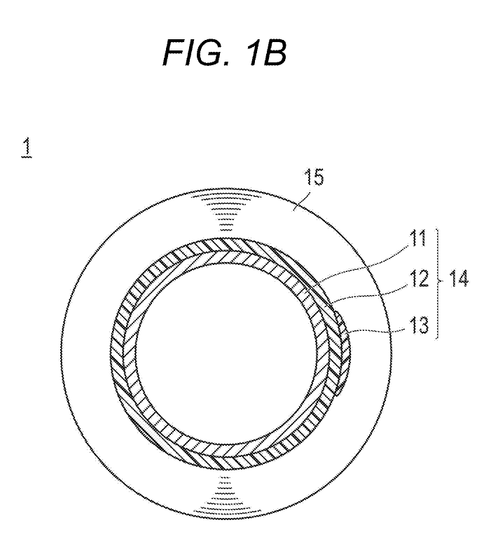

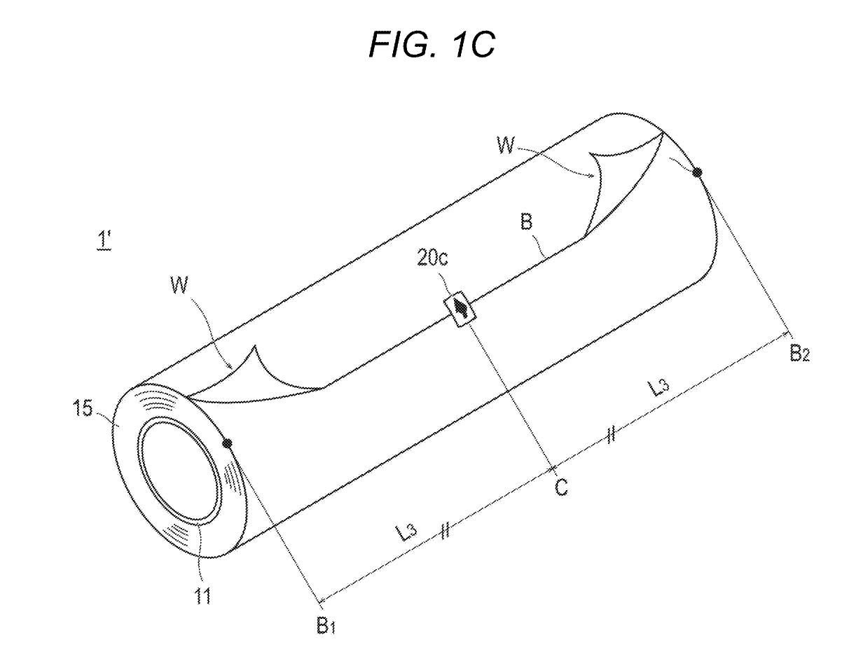

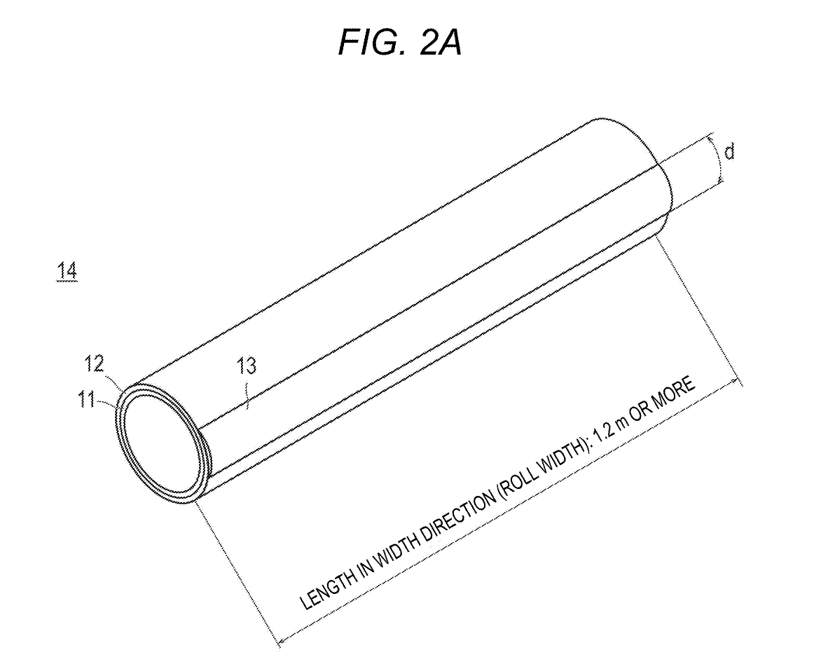

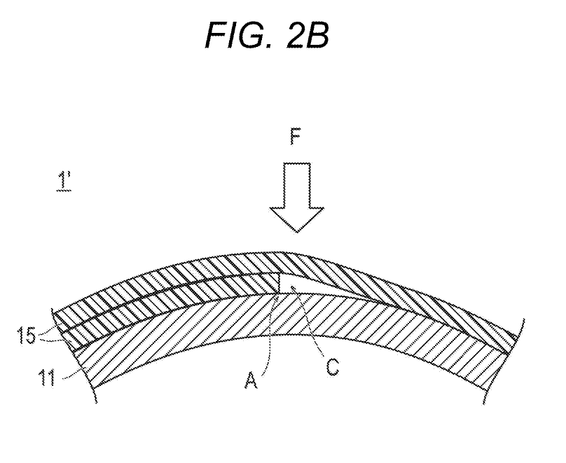

FIG. 1A is a schematic perspective view illustrating the representative configuration of an optical reflective film roll used in an embodiment of the present invention. FIG. 1B is a cross-sectional view perpendicular to the width direction (axis direction) of FIG. 1A. FIG. 1C is a schematic perspective view illustrating the representative configuration of an optical reflective film roll of a related art. FIG. 2A is a schematic perspective view illustrating the configuration of a cushion core portion of the optical reflective film roll of FIG. 1A. FIG. 2B is a partial cross-sectional view perpendicular to the width direction (axis direction) illustrating a state where a winding start end portion (winding-up end) of a light reflective film is attached to the core main body of FIG. 1C.

As illustrated in FIGS. 1A to 1C and FIG. 2A, an optical reflective film roll 1 of this embodiment includes a core main body 11 formed in a cylindrical shape and having a length (the length represented by the symbol L in FIG. 1A) in a width direction of 1.2 m or more and a cushion layer 12 formed by a foamed resin and provided on an outer surface of the core main body. These members are collectively referred to as a cushion core 14. Incidentally, in a case where a cushion member (for example, a double-sided adhesive tape having a cushioning property) 13 is provided on a part of the outer surface of the cushion layer 12, the above members and the cushion member 13 are collectively referred to as the cushion core 14 (see FIG. 2A).

Further, it is desirable that the winding start end portion (the end portion at the center side) of the light reflective film is attached to the cushion layer 12 provided on the core main body 11 by the cushion tape 13. The reason for this is that when a double-sided adhesive tape used for attaching the light reflective film 15 to the cushion core 14 at the winding start end portion is used as the cushion member having pressure sensitive adhesive layers on both surfaces thereof (in other words, a double-sided adhesive tape having a cushion layer) 13, unevenness confirmed by irradiation with sunlight can be considerably reduced. From the viewpoint of productivity and applicability, the entire region of the winding start end portion (the end portion at the center side) of the light reflective film is not necessarily attached by the cushion member 13, and a part of the end portion may be protruded. From the viewpoint of productivity and applicability, conversely, the winding start end portion (the end portion at the center side) of the light reflective film may be only attached by a part of the cushion member 13.

Further, the basic configuration of the optical reflective film roll 1 of this embodiment is a configuration including the core main body 11, the cushion layer 12 formed by a foamed resin and provided on an outer surface of the core main body 11, and a light reflective film 15 having a light reflective membrane, which has a reflection unit formed by alternately laminating a high refractive index layer and a low refractive index layer, a pressure sensitive adhesive layer on one outermost layer of the light reflective membrane, and a hard coat (HC) layer on the other outermost layer, in which the light reflective film 15 is wound up on the outer surface of the cushion layer 12. Furthermore, for the light reflective film 15, in addition to the above-described basic configuration, for example, it is desirable to employ a configuration in which a separator+the pressure sensitive adhesive layer+the light reflective membrane+PET (substrate)+the HC layer are laminated in this order. The reason for this is that when the separator is provided on the outermost layer, there is no concern that the pressure sensitive adhesive layer is attached to an object other than a target object (glass) when the light reflective film 15 is taken out or cut from the optical reflective film roll, and thus, for example, work efficiency is excellent so that convenience is improved. Further, attachment of the light reflective film may be performed by removing the separator immediately before the attachment to the target object (glass) and exposing the pressure sensitive adhesive layer. Incidentally, as the separator (release layer), conventionally known separators can be suitably used.

The near-infrared light reflective film of the related art (for example, Patent Literature 1) is typically stored and transported in the form of the light reflective film roll. The mechanism that unevenness visually confirmed by irradiation with sunlight occurs depending on the form of the light reflective film roll when a necessary amount of the near-infrared light reflective film is taken out and cut from the light reflective film roll and then the cut near-infrared light reflective film is attached to a window or glass of a vehicle after storing and transporting the near-infrared light reflective film, is considered as follows, thereby leading to the completion of the present invention.

That is, it is found out that, in a light reflective film roll 1′ in which the light reflective film 15 is wound up on the core main body 11 such as a paper core or a plastic core, when force F is applied to the end portion (winding-up end) at which the light reflective film 15 is started to be wound up or the vicinity thereof, particularly, to the light reflective membrane having a reflection unit formed by alternately laminating a high refractive index layer and a low refractive index layer, the application of the force F to this portion causes unevenness visually confirmed by irradiation with sunlight (see FIG. 1C and FIG. 2B). In particular, as illustrated in FIG. 2B, in the core main body 11, which has no cushion property and is hard, of the near-infrared light reflective film roll 1′ of the related art, the light reflective film 15 is folded and bent at the winding start end portion (the portion of the symbol A in the drawing) of the light reflective film 15 and a slight gap (the portion of the symbol C in the drawing) is generated. Due to this, a step difference is generated between the winding start end portion A of the light reflective film 15 at the first winding-up and the end portion at the second (subsequent) winding-up. Therefore, the force F is applied to the step difference portion of the light reflective film 15, the light reflective film 15 at the second (subsequent) winding-up is pressed and bent so as to bury the slight gap C, and thus a unique fine defect is generated on the light reflective film 15 using the light reflective membrane which has a reflection unit structure in which a high refractive index layer and a low refractive index layer are alternately laminated. According to this, it is considered that unevenness, which cannot be visually confirmed by irradiation with a fluorescent lamp but is visually confirmed by irradiation with sunlight, occurs. Based on this finding, in the present invention, it is found out that when the light reflective film 15 is wound up on the cushion core 14 having the cushion layer 12 (preferably the cushion member 13), application of a predetermined force F to the light reflective membrane, which has a reflection unit formed by alternately laminating a high refractive index layer and a low refractive index layer, can be prevented and unevenness visually confirmed by irradiation with sunlight can also be reduced, whereby the present invention is achieved (see FIGS. 1A and 1B and FIGS. 2A and 2B). In particular, in the cushion core 14 of the near-infrared light reflective film roll 1 of the present invention, the winding start end portion of the light reflective film 15 is wound up on the cushion core 14 with a constant tension also at the second (subsequent) winding-up so that the winding start end portion of the light reflective film 15 is pressed down against the cushion layer 12, and further against the cushion member 13. Thus, the step difference is absorbed (winding-up is carried out without occurrence of any step difference) without occurrence of any gap. Therefore, even when the force F is applied to the relevant portion of the light reflective film 15, since neither a slight gap nor a step difference is generated, the light reflective film 15 at the second (subsequent) winding-up is almost not pressed and bent, and also, a fine defect is almost not generated. Accordingly, it is considered that unevenness, which cannot be visually confirmed by irradiation with a fluorescent lamp but is visually confirmed by irradiation with sunlight, can be significantly reduced or resolved (see Table 2).

In the present invention, when the double-sided adhesive tape used for attaching the winding start end portion of the light reflective film 15 to the cushion core 14 is used as the cushion member 13 having pressure sensitive adhesive layers on both faces, since the light reflective film 15 is not pushed and bent and a step difference is absorbed so as to achieve a state where a fine defect does not occur (the winding-up is performed without occurrence of the step difference), the above-described effect can be further improved. As a result, it is found out that unevenness, which cannot be visually confirmed by irradiation with a fluorescent lamp but is visually confirmed by irradiation with sunlight, can be removed (resolved) (see FIGS. 1A and 1B, FIG. 2A, and Table 2).

Further, in the present invention, it is found out that, in the winding finish end portion (the portion of the symbol B in FIG. 1A) of the light reflective film 15 of the light reflective film roll 1 which has the same length in the width direction as the core main body 11 having a length in the width direction of 1.2 m or more, when the position at which the tape is attached (which is taped by a tape) is set to two or more and the position is specified, the turning-up of the end portion in the width direction (the portion of the symbol W in FIG. 1C) of the light reflective film roll 1 does not occur and there is no problem in applicability (for example, curl can be prevented from occurring when the light reflective film is attached to glass of a vehicle or the like and application can be performed smoothly in a short time) (see FIGS. 1A and 1C).

That is, in the present invention, the winding finish end portion (the portion of the symbol B in FIG. 1A) of the light reflective film 15 of the light reflective film roll 1 is taped by tapes 20a, 20b, . . . (hereinafter, not illustrated) at two or more positions (in FIG. 1A, a state where two positions are taped is illustrated), and the positions of the tapes 20a and 20b from the end portions in the width direction (the portions of the symbols B₁ and B₂ in FIG. 1A) of the light reflective film roll 1 are preferably 5 to 30 cm, more preferably 10 to 25 cm, still more preferably 15 to 25 cm, and particularly preferably in a range of 20±2 cm. The end portions in the width direction of the light reflective film roll 1 described herein indicate corner portions (Portions of the symbols B₁ and B₂ in FIG. 1A) at further both end portions in relation to the winding finish end portion (the portion of the symbol B in FIG. 1A) of the light reflective film 15. Therefore, when the positions (the portions of the symbols L₁ and L₂ in FIG. 1A) of the tapes 20a and 20b from the end portions B₁ and B₂ in the width direction of the light reflective film roll 1 are 5 cm or more, it is excellent in that the center (center portion; the portion of the symbol C in FIG. 1A) of the winding finish end portion of the light reflective film 15 does not float (is not turned up) and the winding-up state can be maintained. On the other hand, when the positions of the tapes 20a and 20b from the corner portions B₁ and B₂ at further both end portions in relation to the winding finish end portion (the portion of the symbol B in FIG. 1A) of the light reflective film 15 are 30 cm or less, it is excellent in that the corner portions B₁ and B₂ at further both end portions in relation to the winding finish end portion B of the light reflective film 15 are not turned up (curl can be prevented from occurring) and the winding-up state can be maintained. In consideration of the balance of floating or turning-up of both of the corner portions B₁ and B₂ at further both end portions in relation to the winding finish end portion B of the light reflective film 15 and the center C of the winding finish end portion, the positions (the lengths represented by the symbols L₁ and L₂ in FIG. 1A) of the tapes 20a and 20b from the end portions in the width direction (the portions of the symbols B₁ and B₂ in FIG. 1A) of the light reflective film roll 1 are desirably set to about 20±2 cm.

Herein, regarding the positions (the lengths represented by the symbols L₁ and L₂) of the tapes 20a and 20b from both the end portions in the width direction (B₁ and B₂) of the light reflective film roll 1, the position of the tape 20a closest to the end portion at one side (left side) in the width direction of the light reflective film roll 1 is designated as a distance (the length represented as L₁) from the end portion B₁ at one side (left side) to the center position of the width of the tape 20a and the position of the tape 20b closest to the end portion at the other side (right side) in the width direction of the light reflective film roll 1 is designated as a distance (the length represented as L₂) from the end portion B₂ at the other side (right side) to the center position of the width of the tape 20b. The respective distances satisfy the above requirement.

Further, in the present invention, the winding finish end portion (B) of the light reflective film is taped by the tapes 20a and 20b at two or more positions (in FIG. 1A, a state where two positions are taped is illustrated), preferably at two or three positions, and particularly preferably at two positions. If a state where two positions are taped is described as an example, the tape positions closest to both (right and left) end portions in the width direction of the light reflective film roll may satisfy the following formula.

(Tape position from end portion in width direction of light reflective film roll/length of reflective film roll in width direction)×100=0.5 to 25% [Mathematical Formula 2]

When “(Tape (20a, 20b) position from end portion (B₁ and B₂) in width direction of light reflective film roll/length (L) of reflective film roll in width direction)×100” in the above formula is 0.5% or more, it is excellent in that the center (center portion; the portion of the symbol C in FIG. 1A) of the winding finish end portion of the light reflective film 15 does not float (is not turned up) and the winding-up state can be maintained. On the other hand, when “(Tape position from end portion in width direction of light reflective film roll/length of reflective film roll in width direction)×100” in the above formula is 25% or less, it is excellent in that the corner portions (B₁ and B₂) at further both end portions in relation to the end portions in the width direction of the light reflective film roll 1 are not turned up, curl can be prevented from occurring, and the winding-up state can be maintained. Preferably, “(Tape position from end portion in width direction of light reflective film roll/length of reflective film roll in width direction)×100” is in a range of 1.0 to 20%.

Herein, regarding the positions of the tapes 20a and 20b from the end portions in the width direction (B₁ and B₂) of the light reflective film roll 1, the position of the tape 20a closest to the left end portion B₁ in the width direction is designated as a distance L₁ from the left end portion B₁ to the center position of the width of the tape 20a and the position of the tape 20b closest to the right end portion B₂ in the width direction is designated as a distance L₂ from the right end portion B₂ to the center position of the width of the tape 20b. The respective distances satisfy the above requirement. Further, the length of the reflective film roll in the width direction indicates the length of the symbol L in FIG. 1A. Thus, the above formula can be abbreviated as (L₁/L)×100=0.5 to 25% or (L₂/L)×100=0.5 to 25%. In addition, the distances from the end portions in the width direction (B₁ and B₂) of the light reflective film roll 1 to the portions of the tapes 20a and 20b closest to the end portions (B₁ and B₂) are each preferably 0 to 25% and more preferably 0.5 to 15% with respect to the length of the reflective film roll in the width direction.

Hereinbefore, the features of the light reflective film roll of the present invention have been described. Hereinafter, each constitution of the light reflective film roll of the present invention will be described simply.

[Core Main Body 11]

The core main body 11 of the present invention may be a cylindrical core main body having a length in the width direction (indicating the length of the symbol L of FIG. 1A) of 1.2 m or more as illustrated in FIG. 1A, and a core main body of a related art can be properly used. For example, a paper core, a paper core impregnated with a resin, a glass epoxy core, a plastic core, a metal (stainless steel) core, or the like can be used. Preferably, it is desirable to use a paper core, a paper core impregnated with a resin, a plastic core, or the like in which weight saving (when the film is wound up by a roll-to-roll method, operational cost, transportation cost, or the like can be reduced) and recycling are achieved. Among them, it is desirable to use a paper core which is inexpensive and friendly to environment (ecology) and in which weight saving and recycling are achieved.

(Length in Width Direction_of Core Main Body 11 which is Cylindrically Formed (Length of Symbol L in FIG. 1A))

When the light reflective film 15 is wound up on the core main body 11, a step difference is generated between the surface of the core main body 11 and the winding start end portion of the light reflective film 15. If the length in the width direction, which is cylindrically formed, of the core main body 11 is 1.2 m or more, deflection occurs in the light reflective film roll 1 due to the weights of the core main body 11 and the light reflective film 15 when both the ends of the core main body 11 are supported. Due to this deflection, stress is applied to the portion, at which the light reflective film is overlapped on the step difference, of the light reflective film 15 wound up on the core main body 11, and thus a fine defect is easily generated on the light reflective film 15 and unevenness is likely to be visually confirmed particularly with sunlight. Therefore, when the length of the core main body 11 in the width direction is 1.2 m or more, it is excellent in that the effect in which unevenness visually confirmed with sunlight can be reduced is significant.

(Outer Diameter of Cylindrical Body of Core Main Body 11)

The outer diameter (core size) of the cylindrical body of the core main body 11 is not particularly limited, and specifically, the outer diameter of the cylindrical body of the core main body 11 is in a range of 5 to 150 mm, but a 3-inch core (outer diameter: 7.62 mm) which is generally used is preferable.

[Cushion Layer 12]

The cushion layer 12 of this embodiment may be formed by a foamed resin and provided on the outer surface of the core main body 11 as illustrated in FIG. 1A and FIG. 1B and can be produced by suitably using a conventionally known production method. For example, there is mentioned a method of applying the foamed resin to the outer surface of the core main body to have a constant thickness while rotating core main body, setting the core main body with a predetermined space (gap) inside a predetermined outer cylindrical body, and then performing foaming operation, but the production method is not limited thereto at all. Accordingly, the cushion core 14 can be formed. Alternatively, the cushion core 14 may be formed in such a manner that a band-shaped cushion sheet formed by a foamed resin is attached to the outer surface of the core main body 11 by winding up the cushion sheet on the outer surface of the core main body 11 in plural times. In this way, a boundary (winding streak) located between adjacent cushion sheets is formed in the cushion layer 12. The cushion sheet is attached to the outer surface of the core main body 11 by winding up the cushion sheet on the core main body 11 obliquely with respect to the center axis thereof. In this case, it is preferable that an adhesive is applied in advance to the outer surface of the core main body 11 or the inner surface of the cushion sheet. Incidentally, the cushion layer 12 may be formed so as to be provided over the entire region of the outer surface of the core main body 11 such that the length in the width direction (the symbol L in the drawing) of the core main body 11 which is cylindrically formed and the length of the cushion layer 12 in the width direction become the same length (see FIG. 1A and FIG. 2A).

(Foamed Resin)

The foamed resin which can be used for formation of the cushion layer 12 is not particularly limited as long as it can effectively exhibit the above-described effect (effect of reducing or resolving the unevenness visually confirmed by irradiation with sunlight). Specifically, polyethylene foam is preferable; however, in addition to this, polyurethane foam can also be used.

[Cushion Core 14]

The cushion core 14 of the present invention has the configuration illustrated in FIG. 2A (there may be a case where the cushion member 13 is not included).

(Thickness of Cushion Core 14)

The thickness of the cushion core 14 of the present invention (excluding the thickness of the cushion member 13) is in a range of preferably 1 to 20 mm and more preferably 3 to 10 mm. When the thickness of the cushion core 14 is in the above range, it is excellent in that the above-described effect (effect of reducing or resolving the unevenness visually confirmed by irradiation with sunlight) can be effectively exhibited.

(Proportion of Cushion Layer 12 to Cushion Core 14)

The proportion of the cushion layer 12 to the cushion core 14 of the present invention is preferably 10 to 50% and more preferably 20 to 40% with respect to the thickness of the entire cushion core 14 (excluding the thickness of the cushion member 13). When the proportion of the cushion layer 12 to the cushion core 14 is in the above range, it is excellent in that the above-described effect (effect of reducing or resolving the unevenness visually confirmed by irradiation with sunlight) can be effectively exhibited.

[Cushion Member 13]

The cushion member 13 of the present invention is configured by a double-sided adhesive tape. As illustrated in FIG. 2A, the inner side of the cushion member 13 is attached to the cushion layer 12 provided on the core main body 11. Further, the outer side of the cushion member 13 is configured to be attached with the winding start end portion of the light reflective film (winding-up end). With such a configuration, the cushion core 14 can be formed. When the cushion member 13 is used, it is excellent in that the above-described effect (effect of reducing or resolving the unevenness visually confirmed by irradiation with sunlight) can be efficiently and effectively exhibited. Moreover, it is excellent in that the adhesion force between the winding start end portion of the light reflective film 15 and the cushion layer 12 can be sufficiently obtained. In particular, if a part of the winding start end portion of the light reflective film 15 is not attached to the cushion member 13 at the timing when the rotation of the cushion core 14 is started in order to wind up the light reflective film 15, the light reflective film is peeled off from the cushion core 14. As a result, the light reflective film is folded and bent or twisted (turned up). It is excellent in that such phenomena can be effectively prevented. From such a viewpoint, the winding start end portion of the light reflective film 15 is desirably attached by the cushion member 13. However, from the viewpoint of applicability or the like, if the winding start end portion of the light reflective film 15 is slightly protruded from the cushion core 14, there is no problem as described above and there is no need to perform positioning operation precisely, which is extremely rational and productive. Incidentally, regarding the adhesive force of the cushion member 13, as described below, the cushion member 13 can be configured by using the same adhesive as the double-sided adhesive tape conventionally used. Thus, particularly, if the cushion member has the same level of adhesive force as that of the double-sided adhesive tape conventionally used, the cushion member can be sufficiently used.

(Thickness of Cushion Member 13)

The thickness of the cushion member 13 is in a range of preferably 50 to 200 μm and more preferably 60 to 150 μm. When the thickness of the cushion member 13 is in the above range, it is excellent in that the above-described effect (effect of reducing or resolving the unevenness visually confirmed by irradiation with sunlight) can be effectively exhibited. In addition, it is also excellent in that the cushion member 13 can be reliably bonded to the outer surface of the cushion layer 12 and the inner surface of the light reflective film 15.

(Configuration of Cushion Member 13)

The configuration of the cushion member 13 is not particularly limited, and in the general configuration of the adhesive layer/the substrate/the adhesive layer of the double-sided adhesive tape, a configuration of the adhesive layer/the cushion layer/the substrate/the adhesive layer in which the cushion layer is provided between the substrate and the adhesive layer may be employed. Alternatively, in a case where the cushion layer can be used instead of the substrate, there is no particular limitation on the configuration, for example, a configuration of the adhesive layer/the cushion layer/the adhesive layer may be employed. The cushion member 13 may be produced or a commercially available product may be used as the cushion member.

The material to be used for the substrate of the cushion member 13 is not particularly limited, and a conventionally known material for a substrate which can be used for an existing tape (being not limited to a double-sided adhesive tape) can be used. Specifically, cellophane, a paper material such as Japanese paper, non-woven fabric, or the like can be used, but the material is not limited thereto at all.

There is no particular limitation on an adhesive (pressure sensitive adhesive) to be used for the cushion layer of the cushion member 13, and a conventionally known adhesive which can be used for an existing tape (being not limited to a double-sided adhesive tape) can be used. That is, as the adhesive (pressure sensitive adhesive), various adhesives (pressure sensitive adhesives) which can be attached (adhere) at normal temperature can be selected. For example, a rubber-based adhesive (pressure sensitive adhesive), an acrylic resin-based adhesive (pressure sensitive adhesive), and the like can be selected. Further, a pressure sensitive adhesive (adhesive), which is used in the pressure sensitive adhesive layer of the light reflective film 15, or the like can also be suitably used. Examples of the rubber-based adhesive (pressure sensitive adhesive) include a chloroprene rubber-based adhesive (pressure sensitive adhesive), a nitrile rubber-based adhesive (pressure sensitive adhesive), a styrene-butadiene rubber-based adhesive (pressure sensitive adhesive), and a natural rubber-based adhesive (pressure sensitive adhesive). Incidentally, the natural rubber-based adhesive (pressure sensitive adhesive) is desirable compared with other adhesives (pressure sensitive adhesives) in terms of obtaining excellent adhesion force to the light reflective film.

A cushion material to be used for the cushion layer of the cushion member 13 is not particularly limited, and the foamed resin used in the cushion layer 12 can be used. Specifically, polyethylene foam is preferable, but in addition to this, polyurethane foam or the like can be used. However, the cushion material is not limited thereto at all.

(Shape and Arrangement of Cushion Member 13)

To dispose the cushion member 13 in a band shape over the entire region in the width direction of the outer surface of the cushion layer 12, the cushion member 13 may be arranged such that the length of the cushion layer 12 in the width direction and the length of the cushion member 13 in the width direction become the same length (the symbol L in the drawing) (see FIG. 2A). However, the shape, the length in the width direction (the symbol L), and the arrangement of the cushion member 13 illustrated in FIG. 2A are merely examples, and for example, instead of band-shape arrangement over the entire region in the width direction of the outer surface of the cushion layer 12, the cushion member 13, which has a block shape (a polygonal shape such as a triangular shape or a quadrangular shape (such as a rectangular shape, a square shape, or a rhombus shape), a circular shape, an elliptical shape, or the like), may be arranged over the entire region in the width direction so as to be dotted. Alternatively, for example, the cushion member 13, which has a wave shape, a reticulated shape, a vertically striped shape (the form in which a plurality of the cushion members 13 having an elongated thin striped line are arranged in the width direction with a certain interval), a horizontally striped shape (the cushion member 13 having an elongated thin striped line), or the form in which a plurality of the cushion members having an indeterminate shape are arranged in the width direction with an certain interval, may be arranged over the entire region in the width direction, and there is no limitation on the arrangement of the cushion member. Regarding the shape and the arrangement of the cushion member 13, as illustrated in FIG. 2A, the arrangement in which the cushion member is arranged in a band shape over the entire region in the width direction of the outer surface of the cushion layer 12 enables the entire region in the width direction of the light reflective film 15, which is wound up, to be attached to the cushion layer 12 (the cushion member 13), and thus the problem can be easily resolved in that the light reflective film 15 is peeled off from the cushion layer 12 (the cushion member 13).

(Width of Cushion Member 13)

In the above-described various arrangement aspects (a bend shape or the like) in the width direction on the outer surface of the cushion layer 12, the cushion member 13 may be arranged such that the width of the cushion layer 12 (the length in the width direction) L and the width of the cushion member 13 (the width of the cushion layer is the width from one end to the other end, and in the case of a block shape, may be empty in the middle) becomes the same length L (see FIG. 2A). The width of the cushion member (the length in the width direction) is preferably equal to the roll width L, but in some cases, the width may be divided into several sections in the width direction.

(Length d of Cushion Member 13)

The length of the cushion member 13 (the symbol d in FIG. 2A is the length along the cylindrical shape of the cushion member 13) is in a range of preferably 0.5 to 30 cm and more preferably 1 to 10 cm. When the length d of the cushion member 13 is in the above range, the effect of resolving the unevenness visually confirmed by irradiation with sunlight can be effectively exhibited. In addition, it is also excellent in that the cushion member 13 can be reliably bonded to the outer surface of the cushion layer 12 and the inner surface of the light reflective film 15.

(Adhesive Force of Cushion Member 13)

The adhesive force of the cushion member 13 is not particularly limited as long as it has the same adhesive force as that of the double-sided adhesive tape (not illustrated) used in the light reflective film roll 1′ of the related art. The reason for this is that, similarly to the cushion member 13 of the present invention, the inner side of the double-sided adhesive tape (not illustrated) of the related art itself is attached to the core main body 11 by the double-sided adhesive tape and the outer side of the double-sided adhesive tape is used for the purpose of attaching the winding start end portion of the light reflective film.

(Method of Winding Up Light Reflective Film Using Cushion Member 13)

In the present invention, for example, after the winding start end portion of the light reflective film 15 is attached to the cushion core 14 through the cushion member 13, the light reflective film 15 may be wound up on the cushion core 14 in the roll shape, and there is no particular limitation on the winding-up method. For example, the film roll can be produced by suitably using a conventionally known winding-up method (roll formation method) such as a roll-to-roll method or a laminating method. After completion of winding, as described above, it is preferable that the winding finish end portion (in FIG. 1A, the portion of the symbol B) of the light reflective film roll 1 is taped by the tapes 20a, 20b, and the like at two or more positions (in FIG. 1A, a case where two positions are taped is illustrated).

(Tapes 20a and 20b)

In the light reflective film roll 1, it is preferable that the winding finish end portion (in FIG. 1A, the portion of the symbol B) of the light reflective film 15 is taped by the tapes 20a, 20b, and the like at two or more positions (in FIG. 1A, a case where two positions are taped is illustrated). The reason for this is that since the winding finish end portion of the light reflective film roll 1′ is turned up (see the symbol W in the drawing) in a case where one position is taped by the tape 20c as illustrated in 1C of the related art and thus curl occurs at the time of application, as illustrated in FIG. 1A, the winding finish end portion of the light reflective film roll 1 can be prevented from being turned up as much as possible and it is possible to prevent curl at the time of application. The tapes 20a, 20b, and the like are tapes in which no marks remain, and are not particularly limited as long as they do not tear off the constituent component on the surface of the light reflective film 15. However, it is possible to use the same tape as the tape 20c used in the light reflective film roll 1′ of the related art illustrated in FIG. 1C (the tape is a paper sealing material for temporary taping and the peel-off direction is printed thereon (see arrows in FIGS. 1A and 1C)). Specifically, the tape may have a pressure sensitive adhesive layer on the rear surface of a paper substrate thereof and a thin film may be formed thereon such that printing is easily performed on the surface of the paper substrate. As the pressure sensitive adhesive layer, for example, the pressure sensitive adhesive used in the pressure sensitive adhesive layer of the light reflective film 15 can be suitably used. Also, regarding the size of the tape 20a, 20b, or the like, the same size as or the size equal to the tape 20c used in the light reflective film roll 1′ of the related art illustrated in FIG. 1C can be used. Specifically, if the size is about 5 to 20 cm long×2 to 5 cm wide, the above-described effect can be sufficiently exhibited.

[Light Reflective Film]

The light reflective film 15 of the present invention includes a light reflective membrane having a reflection unit formed by alternately laminating a high refractive index layer and a low refractive index layer, a pressure sensitive adhesive layer at one outermost layer (inner side) of the light reflective membrane, and a hard coat layer at the other outermost layer (outer side) of the light reflective membrane. Further, as illustrated in FIG. 1A and FIG. 1B, the light reflective film 15 is wound up on the outer surface of the cushion layer 12 (further including the cushion member 13). In the present invention, the feature thereof is exhibited in which it is possible to considerably reduce or resolve unevenness, which cannot be visually confirmed by irradiation with a fluorescent lamp but is visually confirmed by irradiation with sunlight, that is a unique technical problem caused by using, in the light reflective film 15 of the light reflective film roll 1, the light reflective membrane having a reflection unit formed by alternately laminating a high refractive index layer and a low refractive index layer. Regarding the light reflective membrane, the present applicant has already conducted a large number of patent applications and most of the patent applications have been published. Thus, regarding the details thereof, the light reflective membrane can be produced while the publications of the present applicant, which are already known, are suitably referred to. Hereinafter, each configuration will be simply described.

The light reflective membrane has an undercoat layer formed on a substrate and a reflection unit formed on the undercoat layer. The reflection unit is configured to include at least one laminate in which a low refractive index layer and a high refractive index layer are laminated. For example, in the case of the configuration in which the number of laminates is nine, a multilayer product of 18 layers (reflection unit) on one face in which nine low refractive index layers and nine high refractive index layers are alternately laminated is formed such that the high refractive index layers are arranged on the bottom layer of the substrate side and the low refractive index layers are arranged on the top layer.

In the present invention, a transparent pressure sensitive adhesive layer is formed on the low refractive index layer of the top layer in the multilayer product of 18 layers (reflection unit) on the one face of the substrate. Further, a HC layer is formed on the other face of the substrate. In this case, by winding off (taking out) the light reflective film 15 from the light reflective film roll 1 of the present invention and then cutting the light reflective film 15 into a suitable size, the pressure sensitive adhesive layer of the light reflective film 15 may be attached to the interior (vehicle interior or room interior) side of a base body such as an automobile window or the glass window of a building.

Further, in the present invention, an example in which an undercoat layer is formed on one face of the substrate is mentioned, but the reflection unit is formed directly on the substrate without formation of the undercoat layer. Further, depending on the usage type, the substrate is not necessarily required, and a configuration in which the substrate is not provided can be employed. Furthermore, a separator (release layer) is provided on the transparent pressure sensitive adhesive layer, and the separator may be removed when the film is attached to the base body. Similarly, a separator (release layer) is also provided on the HC layer, and then the separator may be removed after the film is attached to the base body.

The refractive index layer usable in the light reflective membrane of the present invention may contain a polymer. For example, polymers described in JP 2002-509279 A can be used as the polymer. Specific examples thereof include polyethylene naphthalate (PEN) and an isomer thereof, polyalkylene terephthalate, polyimide, polyether imide, atactic polystyrene, polycarbonate, polymethacrylate, polyacrylate, a cellulose derivative, a polyalkylene polymer, a fluorinated polymer, a chlorinated polymer, polysulfone, polyether sulfone, polyacrylonitrile, polyamide, a silicone resin, an epoxy resin, polyvinyl acetate, polyether amide, an ionomer resin, an elastomer, and polyurethane; however, the polymer is not limited thereto at all and polymers for a refractive index layer described in JP 2002-509279 A can be used without any limitation. Further, a copolymer, for example, a copolymer of PEN, a copolymer of polyalkylene terephthalate, a styrene copolymer, 4,4-bisbenzoic acid, and ethylene glycol are also suitable. Furthermore, the respective layers may contain a blend of two or more kinds of the polymers or copolymers described above (for example, a blend of syndiotactic polystyrene (SPS) and atactic polystyrene).

The reflection unit can be formed by subjecting the polymer described above to melt extrusion and stretching of polymer as described in U.S. Pat. No. 6,049,419. In the present invention, preferred combinations of the polymers that form the high refractive index layer and the low refractive index layer include PEN/polymethyl methacrylate (PMMA), PEN/polyvinylidene fluoride, and PEN/polyethylene terephthalate (PET).

Further, the refractive index layer may be formed as a layer containing a water-soluble binder. For example, the low refractive index layer is formed by a water-based coating liquid for forming a low refractive index layer and is configured to include first metal oxide particles (for example, colloidal silica particles), a water-soluble resin, and a water-based solvent. The high refractive index layer is formed by a water-based coating liquid for forming a high refractive index layer and is configured to include second metal oxide particles (for example, titanium oxide particles), a water-soluble resin, a water-based solvent. In the present invention, an ampholytic surfactant may be contained in the coating liquid which forms at least one layer of the reflection unit formed by these low refractive index layer and high refractive index layer. In the present invention, the first metal oxide particles function as a low refractive index material and the second metal oxide particles function as a high refractive index material.

Further, when a water-based coating liquid A for forming a low refractive index layer and a water-based coating liquid B for forming a high refractive index layer are applied and dried, a low refractive index layer is formed by the water-based coating liquid A containing the first metal oxide particles as the low refractive index material and the water-soluble resin, and a high refractive index layer is formed by the coating liquid B containing the second metal oxide particles as the high refractive index material and the water-soluble resin. When application and drying of this coating liquid A and this coating liquid B are repeatedly performed, a reflection unit (for example, a multilayer product of 18 layers) can be formed. Alternatively, a reflection unit (for example, a multilayer product of 18 layers on one face) may be formed in such a manner that simultaneous multilayer coating of the coating liquid A and the coating liquid B is performed and then the coating liquids are dried to form a multilayer product of nine layers, and similarly, simultaneous multilayer coating of the coating liquid A and the coating liquid B is performed on the obtained multilayer product and then the coating liquids are dried to form a multilayer product of nine layers.

In general, it is preferable for the light reflective membrane to design the difference between the refractive indices of the low refractive index layer and the high refractive index layer to be large, from the viewpoint that higher infrared reflectivity can be obtained with a smaller number of layers. In the present invention, for at least one reflection unit formed by the low refractive index layer and the high refractive index layer, the difference between the refractive indices of adjacent low refractive index layer and high refractive index layer is preferably 0.1 or more and more preferably 0.3 or more. In a case where the light reflective membrane has a plurality of reflection units of the high refractive index layer and the low refractive index layer, it is preferable that the difference between the refractive indices of the high refractive index layer and the low refractive index layer in all of the reflection units is in the suitable range described above. However, regarding the top layer and the bottom layer, configurations other than the suitable range may also be employed. Further, the refractive index of the low refractive index layer is preferably 1.10 to 1.60 and more preferably 1.30 to 1.50. In addition, the refractive index of the high refractive index layer is preferably 1.80 to 2.50 and more preferably 1.90 to 2.20. Incidentally, the measurement of the refractive index can be performed by the method described below.

(Measurement of Single Membrane Refractive Index of Each Layer)

Samples are prepared by coating each of target layers (high refractive index layer and low refractive index layer) for the refractive index measurement on a substrate in a single layer, respectively, and the refractive index of each of the high refractive index layer and the low refractive index layer is obtained according to the following method.

A surface roughening treatment is carried out on aback side serving as a measurement side of each sample, alight absorbing treatment is then carried out with a black spray to prevent light reflection in the back side and a reflectivity in a visible light region (400 nm to 700 nm) is measured in a condition of 5° regular reflection, and as a result, the refractive index is determined by using U-4000 Type (manufactured by Hitachi, Ltd.) as a spectrophotometer.

The reflectivity in a specific wavelength region is determined by the difference in refractive index between two adjacent layers and the number of laminated layers, and the same reflectivity is obtained by a smaller number of layers as the difference in refractive index is larger. This difference in refractive index and the required number of layers can be calculated by using a commercially available optical design software.

As the optical characteristics of the light reflective membrane, the transmittance in the visible light region is 50% or more, preferably 75% or more, and more preferably 85% or more, and it is preferable to have a region where a reflectivity exceeds 50% in the wavelength region of 900 nm to 1400 nm. The measurement of the transmittance in the visible light region can be carried out by JIS R3106-1998. Specifically, in addition to the visible light transmittance of the light reflective film or the light reflective membrane (sample), the infrared transmittance and the infrared reflectivity thereof can be measured by using a spectrophotometer (for example, U-4000 Type: manufactured by Hitachi, Ltd.).

The light reflective membrane may have a configuration which includes at least one laminate (reflection unit) formed by a high refractive index layer and a low refractive index layer. Regarding the preferable number of layers of the high refractive index layer and the low refractive index layer, from the above point of view, the range of the total layer number is 100 layers or less, that is, 50 units or less, and more preferably 40 layers (20 units) or less. In addition, the light reflective membrane of the present invention may have a configuration which includes at least one reflection unit, and for example, may be a light reflective membrane in which the top layer and the bottom layer of the laminated membrane may be either the high refractive index layer or the low refractive index layer. Regarding the light reflective membrane of the present invention, a layer configuration in which the bottom layer adjacent to the substrate is a low refractive index layer and the top layer is also a low refractive index layer is preferable.

Hereinbefore, the configuration of the light reflective membrane provided on the substrate has been described by using, as an example of the configuration of the light reflective film, the layer configuration in which the separator+the pressure sensitive adhesive layer+the light reflective membrane+PET (substrate)+the HC layer are laminated in this order. However, in the present invention, without using the substrate, a configuration in which the high refractive index layer or the low refractive index layer of the bottom layer adjacent to the substrate is decreased in thickness to provide a support function required for the substrate may be employed instead of the substrate. That is, a layer configuration in which the separator+the pressure sensitive adhesive layer+the light reflective membrane (the high refractive index layer or the low refractive index layer of the bottom layer adjacent to the HC layer also functions as the substrate)+the HC layer are laminated in this order may be employed. In this case, a desired laminate (reflection unit) may be formed by sequentially laminating the layers in order from the high refractive index layer or the low refractive index layer of the bottom layer (or by simultaneously laminating the layers).

The thickness of the entire light reflective film 15 is preferably 12 μm to 315 μm and more preferably 15 μm to 200 μm. In addition, the thickness of each low refractive index layer is preferably 20 to 800 nm and more preferably 50 to 350 nm. Meanwhile, the thickness of each high refractive index layer is 20 to 800 nm and more preferably 50 to 350 nm. The thickness of the entire light reflective film, the thickness of each low refractive index layer, and the thickness of each high refractive index layer can be obtained by measuring the cut surface of the light reflective film with a scanning electron microscope (SEM). Incidentally, in a case where a layer (mixed layer) including a high refractive index layer component and a low refractive index layer component is formed, the thicknesses can be obtained by performing measurement with the above-described XPS surface analyzer and EDX.

The light reflective film may have one or more functional layers for the purpose of imparting an additional function. Examples of the functional layers include a conductive layer, an antistatic layer, a gas barrier layer, an easily adhesive layer (adhesive layer), an antifouling layer, a deodorant layer, an anti-dropping layer, a slippery layer, a hard coat layer, an abrasion resistant layer, an antireflection layer, an electromagnetic wave shielding layer, an ultraviolet absorbing layer, an infrared absorbing layer, a printing layer, a fluorescence emitting layer, a hologram layer, a release layer, a pressure sensitive adhesive layer, an adhesive layer, an infrared cutting layer (a metal layer and a liquid crystal layer) other than the high refractive index layer and the low refractive index layer of this embodiment, a colored layer (visible light absorbing layer), and an intermediate membrane layer used in a laminated glass.

[Water-Soluble Resin]

A binder resin can be used in the formation of the light reflective membrane. The binder resin is preferably formed by a water-soluble resin. As the water-soluble resin, a polyvinyl alcohol-based resin, gelatin, celluloses, a polysaccharide thickener, and a polymer having a reactive functional group are preferable and a polyvinyl alcohol-based resin is particularly preferable. These water-soluble resins may be used singly or as a mixture of two or more kinds thereof.

(Polyvinyl Alcohol-Based Resin)

As a polyvinyl alcohol-based resin used as a water-soluble resin, a polyvinyl alcohol-based resin having a polymerization degree (average polymerization degree) of 1500 to 7000 is preferable and a polyvinyl alcohol-based resin having a polymerization degree of 2000 to 6000 is more preferable.

Herein, the polymerization degree (P) indicates a viscosity average polymerization degree and is a value which is measured according to JIS-K6726 (1994) and obtained by the following formula from the intrinsic viscosity [η] (dl/g) measured in water at 30° C. after purifying the polyvinyl alcohol-based resin by the complete re-saponification.

P=([η]×10³/8.29)^{(1/0.62)} [Mathematical Formula 3]

As the method of comparing a difference in polymerization degree between refractive index layers, in a case where the refractive index layers respectively contain a plurality of polyvinyl alcohol-based resins having different polymerization degrees from one another, a value obtained by averaging polymerization degrees of the polyvinyl alcohol-based resins contained in the refractive index layer is employed as the “polymerization degree.”

In the light reflective membrane, it is preferable that a high refractive index layer and a low refractive index layer contain polyvinyl alcohol-based resins having different saponification degrees from each other. Either of the high refractive index layer or the low refractive index layer may have a higher value of a saponification degree than the other; however, it is more preferable that the saponification degree of polyvinyl alcohol contained in the high refractive index layer is higher than the saponification degree of polyvinyl alcohol contained in the low refractive index layer.

Further, a difference between the absolute values of the saponification degrees of the polyvinyl alcohol-based resin contained in the low refractive index layer and the polyvinyl alcohol-based resin contained in the high refractive index layer is preferably 3% by mol or more and more preferably 5% by mol or more.

Herein, the saponification degree is the proportion of the hydroxyl group to the total number of the acetyloxy group (derived from vinyl acetate of the raw material) and the hydroxyl group in the polyvinyl alcohol-based resin.

A polyvinyl alcohol-based resin of which a difference in saponification degree is compared in each refractive index layer is a polyvinyl alcohol-based resin having the highest content in the refractive index layer in a case where each refractive index layer contains a plurality of polyvinyl alcohol-based resins (having different saponification degrees). Herein, when the “polyvinyl alcohol-based resin having the highest content in the refractive index layer” is referred to, a polyvinyl alcohol-based resin having a difference in saponification degree within 3% by mol is regarded as an identical polyvinyl alcohol-based resin and a saponification degree is calculated. However, a polyvinyl alcohol-based resin having a low polymerization degree of less than 1000 is regarded as a different polyvinyl alcohol-based resin (even if there is a polyvinyl alcohol-based resin having a difference in saponification degree within 3% by mol, it is not regarded as an identical polyvinyl alcohol-based resin).

In a case where polyvinyl alcohol-based resins having saponification degrees different by 3% by mol or more from one another are contained in the same layer, the polyvinyl alcohol-based resins are regarded as a mixture of different polyvinyl alcohol-based resins and the saponification degrees are respectively calculated.

The saponification degrees of the polyvinyl alcohol-based resin contained in the low refractive index layer and the polyvinyl alcohol-based resin contained in the high refractive index layer are preferably 75% by mol or more from the solubility of the polyvinyl alcohol-based resin in water, respectively. Further, one of the polyvinyl alcohol-based resin contained in the low refractive index layer and the polyvinyl alcohol-based resin of the high refractive index layer has a saponification degree of 90% by mol or more and the other has a saponification degree of less than 90% by mol.

Examples of the polyvinyl alcohol-based resin which is preferably used include an ordinary polyvinyl alcohol (unmodified polyvinyl alcohol) obtained by hydrolysis of polyvinyl acetate, and also include a cation-modified polyvinyl alcohol having a cation-modified terminal, an anion-modified polyvinyl alcohol having an anionic group, a nonion-modified polyvinyl alcohol, a modified polyvinyl alcohol that is modified by acryl and the like, and a vinyl acetate-based resin (a vinyl alcohol-based polymer). In addition, a polyvinyl acetal resin obtained by reacting aldehyde with polyvinyl alcohol, silanol-modified polyvinyl alcohol having a silanol group, and the like are also included. Two or more kinds of these polyvinyl alcohol-based resins can also be concurrently used depending on a polymerization degree, a difference in kind of modification, and the like.

In the present specification, the term “water-soluble” means a compound which is dissolved to be 1% by mass or more with respect to a water medium.

The cation-modified polyvinyl alcohol is, for example, a polyvinyl alcohol having a primary to tertiary amino group and a quaternary ammonium group in the main chain or a side chain of the above polyvinyl alcohol as described in JP 61-10483 A and can be obtained by saponifying a copolymer of an ethylenically unsaturated monomer having a cationic group and vinyl acetate.

Examples of the ethylenically unsaturated monomer having a cationic group include exemplary compounds of ethylenically unsaturated monomers having a cationic group as described in Paragraph [0067] of JP 2013-44916 A. The proportion of the cation-modified group-containing monomer in the cation-modified polyvinyl alcohol is 0.1 to 10% by mol and preferably 0.2 to 5% by mol with respect to vinyl acetate.

Examples of the anion-modified polyvinyl alcohol include a polyvinyl alcohol having an anionic group as described in JP 1-206088A, a copolymer of vinyl alcohol and a vinyl compound having a water-soluble group as described in JP 61-237681 A and JP 63-307979 A, and a modified polyvinyl alcohol having a water-soluble group as described in JP 7-285265 A.

Further, examples of the nonion-modified polyvinyl alcohol include a polyvinyl alcohol derivative obtained by adding a polyalkylene oxide group to a part of vinyl alcohol as described in JP 7-9758 A and a block copolymer of a vinyl compound having a hydrophobic group and vinyl alcohol as described in JP 8-25795 A. The polyvinyl alcohol can also be used in combination of two or more kinds, for example, different in polymerization degree or modification.

In addition, examples of the vinyl acetate-based resin (vinyl alcohol-based polymer) include EXCEVAL (trade name: manufactured by KURARAY CO., LTD.). Examples of the modified polyvinyl alcohol include Nichigo G-Polymer (trade name: manufactured by The Nippon Synthetic Chemical Industry Co., Ltd.).

The silanol-modified polyvinyl alcohol is not particularly limited, and a product synthesized by a known method or a commercially available product may be used.

Further, the high refractive index layer preferably contains silanol-modified polyvinyl alcohol. When the high refractive index layer contains silanol-modified polyvinyl alcohol, the content of the silanol-modified polyvinyl alcohol is preferably 1 to 40% by mass and more preferably 2 to 30% by mass with respect to 100% by mass of the total solid content of the high refractive index layer.

The content of the polyvinyl alcohol-based resin (total polyvinyl alcohol-based resin) is preferably in a range of 5 to 50% by mass and more preferably 10 to 40% by mass with respect to 100% by mass of the total mass (solid matter) of each refractive index layer. Incidentally, in the present specification, the term “membrane surface” means the surface of the coating membrane and is also referred to as the “surface” in some cases.

The total polyvinyl alcohol-based resin means the total amount of the polyvinyl alcohol-based resins contained in respective refractive index layers. For example, a low-polymerization-degree polyvinyl alcohol-based resin having a polymerization degree of less than 1000, or the like is also included in the content of the total polyvinyl alcohol-based resin.

[Protective Agent]

The low refractive index layer and/or the high refractive index layer preferably contain a water-soluble resin to coat metal oxide particles. Hereinafter, the water-soluble resin to coat metal oxide particles will be described. Incidentally, the water-soluble resin has a function to allow easy dispersion of metal oxide particles in a solvent, and hereinafter, is referred to as the “protective agent.”

As the protective agent, a water-soluble resin has a polymerization degree of preferably 100 to 700 and more preferably 200 to 500. In addition, a polyvinyl alcohol-based resin is preferable and a modified polyvinyl alcohol is more preferable. Further, the saponification degree of polyvinyl alcohol is preferably 95% by mol or more and more preferably 98 to 99.5% by mol. The description of the polyvinyl alcohol-based resin is omitted since the polyvinyl alcohol-based resin is described in the section of the polyvinyl alcohol-based resin.

The content of the protective agent is preferably in a range of 0.1 to 30% by mass and more preferably 0.5 to 20% by mass with respect to 100% by mass of the metal oxide particles.

[Curing Agent]

The low refractive index layer and/or the high refractive index layer may contain a curing agent.

The curing agent which can be used together with the polyvinyl alcohol-based resin is not particularly limited as long as it causes a curing reaction with the polyvinyl alcohol-based resin, and is preferably selected from the group consisting of boric acid, a borate salt, and borax. Specific examples of the curing agent include an epoxy-based curing agent, an aldehyde-based curing agent, an active halogen-based curing agent, an active vinyl-based compound, and aluminum alum.

Boric acid or a borate salt refers to an oxygen acid having a boron atom as the central atom and a salt thereof.

Borax is a mineral represented by Na₂B₄O₅(OH)₄.8H₂O (sodium tetraborate (Na₂B₄O₇) decahydrate).

Boric acid and a borate salt having a boron atom, and borax as the curing agents may be used singly as an aqueous solution or as a mixture of two or more kinds thereof. A mixed aqueous solution of boric acid and borax is particularly preferable.

In the present invention, it is preferable to use boric acid and a salt thereof and/or borax.

The total use amount of the curing agent is preferably 1 to 600 mg and more preferably 100 to 600 mg per 1 g of the binder resin.

[Metal Oxide Particles]

The high refractive index layer and/or the low refractive index layer preferably contain metal oxide particles.

[Metal Oxide Particles in Low Refractive Index Layer (First Metal Oxide Particles)]

As first metal oxide particles used in the low refractive index layer, for example, zinc oxide; silicon dioxide such as synthetic amorphous silica or colloidal silica; alumina; and colloidal alumina can be mentioned. The first metal oxide particles may be used singly or in combination of two or more kinds thereof.

As the first metal oxide particles, silicon dioxide is preferably used, and colloidal silica is particularly preferably used.

The average particle diameter (number average) of the first metal oxide particles is preferably 1 to 100 nm and more preferably 3 to 50 nm. In the present specification, the average particle diameter (number average) of metal oxide fine particles is determined as a simple average value (number average) by observing particles themselves or particles appearing on a cross section and surface of the refractive index layer with an electron microscope and measuring particle diameters of 1000 arbitrary particles. Herein, the particle diameter of the individual particles is expressed as the diameter when assuming a circle equal to the projected area thereof. Examples of colloidal silica used in the present invention include those described in JP 57-14091 A, JP 60-219083 A, JP 60-219084 A, JP 61-20792 A, JP 61-188183 A, JP 63-17807 A, JP 4-93284 A, JP 5-278324A, JP 6-92011A, JP 6-183134 A, JP 6-297830 A, JP 7-81214 A, JP 7-101142 A, JP 7-179029 A, JP 7-137431 A, and WO 94/26530 A.

A synthetic product may be used as such colloidal silica, and a commercially available product may also be used. Examples of the commercially available product include SNOWTEX series (SNOWTEX OS, OXS, S, OS, 20, 30, 40, O, N, C, or the like) sold by NISSAN CHEMICAL INDUSTRIES, LTD.

The colloidal silica may be cation-modified on the surface or may also be treated with Al, Ca, Mg, or Ba.

The content of the first metal oxide particles in the low refractive index layer is preferably 20 to 75% by mass and more preferably 30 to 70% by mass with respect to 100% by mass of the total solid content of the low refractive index layer.

[Metal Oxide Particles in High Refractive Index Layer (Second Metal Oxide Particles)]

The high refractive index layer preferably contains second metal oxide particles. The second metal oxide particles which may be contained in the high refractive index layer are preferably metal oxide particles different from those in the low refractive index layer.

As the metal oxide particles used in the high refractive index layer, for example, titanium oxide, zirconium oxide, zinc oxide, alumina, colloidal alumina, niobium oxide, europium oxide, and zircon can be mentioned. The second metal oxide may be used singly or in combination of two or more kinds thereof.

To form a high refractive index layer having transparency and a higher refractive index, the high refractive index layer preferably contains metal oxide particles having a high refractive index, that is, titanium oxide particles or zirconium oxide particles. In addition, the high refractive index layer more preferably contains rutile type (tetragonal system) titanium oxide particles having a volume average particle diameter of 100 nm or less. Further, a plurality of kinds of titanium oxide particles may be mixed.

Further, the first metal oxide particles contained in the low refractive index layer and the second metal oxide particles contained in the high refractive index layer are preferably made a state of same ionicity (that is, same charge sign). Examples of means for being the same ionicity include, in a case where silicon dioxide (anion) is used in the low refractive index layer and titanium oxide (cation) is used in the high refractive index layer, a method in which silicon dioxide is treated with aluminum or the like so as to be cationized or a method in which titanium oxide is treated with a silicon-containing hydrous oxide so as to be anionized.

Further, the volume average particle diameter of the second metal oxide particles contained in the high refractive index layer is particularly preferably 50 nm or less and more preferably 1 to 45 nm.

The volume average particle diameter described herein is the volume average particle diameter of primary particles or secondary particles dispersed in a medium and can be measured by a laser diffraction/scattering method, a dynamic light scattering method, or the like. Specifically, particles themselves or particles appearing on a cross section or surface of the refractive index layer are observed with an electron microscope and the particle diameters of arbitrary 1000 particles are measured, and when a volume per one particle is assumed to be vi, an average particle diameter weighted by a volume, which is expressed by a volume average particle diameter mv={Σ(vi·di)}/{Σ(vi)}, is calculated in a group of metal oxide particles in which particles each having a particle diameter of d1, d2 . . . di . . . dk are present respectively in the number of n1, n2 . . . ni . . . nk.

Further, the metal oxide particles are preferably monodispersed. The term “monodispersed” described herein refers to that the monodispersity determined by the following formula is 40% or less. This monodispersity is more preferably 30% or less. The average value of particles in the following formula for monodispersity indicates a volume average value of particles.

Monodispersity=(standard deviation of particle diameter)/(average value of particle diameter)×100 [Mathematical Formula 4]

The content of the metal oxide particles in the high refractive index layer is preferably 15 to 85% by mass and more preferably 20 to 80% by mass with respect to 100% by mass of the total solid content of the high refractive index layer.

Titanium oxide particles preferably used as the second metal oxide particles are particles by modifying the surface of titanium oxide sol and being a dispersible state in water, an organic solvent, or the like.

As a preparation method of the water-based titanium oxide sol, for example, it is possible to refer to the matters described in JP 63-17221 A, JP 7-819 A, JP 9-165218 A, JP 11-43327 A, JP 63-17221 A, and the like.

In a case where titanium oxide particles are used as the second metal oxide particles, as another production method of titanium oxide particles, for example, it is possible to refer to the method described in “Titanium Oxide—Physical Properties and Application Technology” Manabu SEINO, pp. 255 to 258 (2000), GIHODO SHUPPAN Co., Ltd. or the method of the step (2) described in Paragraphs from [0011] to [0023] in WO 2007/039953 A.

The production method in the step (2) described above includes a step (1) of treating titanium dioxide hydrate with at least one basic compound selected from the group consisting of hydroxides of alkali metals and hydroxides of alkali earth metals and a step (2) of treating the obtained titanium dioxide dispersion with a carboxylic acid group-containing compound and an inorganic acid after the step (1).

Further, the second metal oxide particles of the present invention are preferably in the form of core-shell particles in which titanium oxide particles are covered with a silicon-containing hydrous oxide. The core-shell particles have a structure in which the volume average particle diameter of titanium oxide particles serving as the core is preferably more than 1 nm but less than 30 nm and the surface of titanium oxide particles is covered with a shell formed by silicon-containing hydrous oxide such that the coating amount of the silicon-containing hydrous oxide is 3 to 30% by mass as SiO₂ with respect to 100% by mass of titanium oxide serving as the core.

The silicon-containing hydrous oxide in the present specification may be any one of a hydrate of an inorganic silicon compound, a hydrolysate and/or condensate of an organic silicon compound, but more preferably has a silanol group. Thus, as the second metal oxide particles, silica-modified (silanol-modified) titanium oxide particles in which the titanium oxide particles are silica-modified are preferable.

The coating amount of the silicon-containing hydrous compound of titanium oxide is 3 to 30% by mass and preferably 3 to 10% by mass as SiO₂ with respect to 100% by mass of titanium oxide.

Further, as the second metal oxide particles, core-shell particles produced by a known method can be used. For example, core-shell particles produced by the methods described in JP 10-158015 A, JP 2000-053421 A, JP 2000-063119 A, JP 2000-204301 A, JP 4550753 B1, and the like.

[Other Additives of Refractive Index Layer]

The high refractive index layer and the low refractive index layer can contain various kinds of additives as necessary. For example, it is possible to contain various kinds of known additives such as ultraviolet absorbing agents described in JP 57-74193 A, JP 57-87988 A, and JP 62-261476 A, anti-fading agents described in JP 57-74192 A, JP 57-87989 A, JP 60-72785 A, JP 61-146591 A, JP 1-95091 A, and JP 3-13376 A, fluorescent whitening agents described in JP 59-42993 A, JP 59-52689 A, JP 62-280069 A, JP 61-242871 A, and JP 4-219266, pH adjusting agents such as sulfuric acid, phosphoric acid, acetic acid, citric acid, sodium hydroxide, potassium hydroxide, and potassium carbonate, antifoaming agents, lubricants such as diethylene glycol, preservatives, antistatic agents, and matting agents.

(Pressure Sensitive Adhesive Layer)

The pressure sensitive adhesive layer is used in one outermost layer of the light reflective membrane. For the pressure sensitive adhesive layer used for attaching the light reflective film wound off from the light reflective film roll to a base body (for example, glass), the light reflective film wound off from the light reflective film roll is preferably arranged in the sunlight (heat ray) entrance side. In addition, a laminated glass can also be used in such a manner that the pressure sensitive adhesive layer of the light reflective film wound off from the light reflective film roll 1 is attached to the base body side and the light reflective film is interposed between the window glass and the base body. Moreover, the pressure sensitive adhesive layer of the light reflective film wound off from the light reflective film roll may be attached to the window of a building or the outside of the windshield of a vehicle (for outdoor pasting) so as to be arranged.

As the pressure sensitive adhesive which is suitable for the pressure sensitive adhesive layer on one outermost layer of the light reflective membrane, a pressure sensitive adhesive containing a photocurable or thermosetting resin as a main component can be used.

A pressure sensitive adhesive which can be applied to the pressure sensitive adhesive layer is preferably those having durability to ultraviolet light, and is preferably an acrylic pressure sensitive adhesive or a silicone-based pressure sensitive adhesive. Further, an acrylic pressure sensitive adhesive is more preferable. In particular, an acrylic solvent-based pressure sensitive adhesive is preferable among acrylic pressure sensitive adhesives. In the case of using a solution polymerization polymer as an acrylic solvent-based pressure sensitive adhesive, a known monomer can be used as its monomer.

In addition, a polyvinyl butyral-based resin used as an intermediate layer of laminated glass or an ethylene-vinyl acetate copolymer-based resin may be used. Specific examples thereof include plastic polyvinyl butyral, an ethylene-vinyl acetate copolymer, and a modified ethylene-vinyl acetate copolymer. Incidentally, an ultraviolet absorbing agent, an antioxidant, an antistatic agent, a heat stabilizer, a lubricant, a filler, a coloring agent, an adhesion control agent, and the like may be appropriately added to and blended in the adhesive layer.

(Hard Coat (HC) Layer)

The HC layer is used for, with respect to one side, at which the pressure sensitive adhesive layer is provided, of the light reflective membrane, the outermost layer at the other side. The HC layer is provided for the purpose of preventing scratches or adhesion of dirt from occurring on the surface of the light reflective film and achieving the curl balance when the light reflective film is attached to a window or the like. The thickness of the HC layer is preferably 0.05 μm or more but 10 μm or less, and more preferably 1 μm or more but 10 μm or less.

The material used for forming the transparent HC layer is not particularly limited as long as transparency, weather resistance, hardness, mechanical strength, and the like can be obtained by using the material. The transparent HC layer can be configured by an acrylic resin, a urethane resin, a melamine resin, an epoxy resin, an organic silicate compound, a silicone resin, or the like. In particular, a silicone resin or an acrylic resin is preferable. The transparent HC layer is more preferably formed by an active energy ray curable acrylic resin or a thermosetting acrylic resin.

The active energy ray curable acrylic resin or the thermosetting acrylic resin is a composition including a polyfunctional acrylate, an acrylic oligomer, or a reactive diluent as a polymerizable curing component. In addition, a composition containing a photopolymerization initiator, a photosensitizer, a thermal polymerization initiator, or a modifier may be used.

The acrylic oligomer refers to a composition including a reactive acrylic group bonded to an acrylic resin skeleton, polyester acrylate, urethane acrylate, epoxy acrylate, polyether acrylate, or the like. In addition, a composition including an acrylic group bonded to a rigid skeleton of melamine, isocyanuric ester, or the like can be used. Incidentally, the oligomer has a large molecular weight to some extent, for example, has a weight average molecular weight of 1000 or more but less than 10000.

Further, the reactive diluent functions as a solvent in the coating step serving as a medium of the coating material. Moreover, the reactive diluent itself has a group reacting with a monofunctional or polyfunctional acrylic oligomer and forms a copolymer component of the coating membrane.

Examples of a commercially available polyfunctional acrylic curing coating material, which can be used, include products manufactured by Mitsubishi Rayon Co., Ltd. (trade name “DIABEAM (registered trademark)” series), manufactured by Nagase & Co., Ltd. (trade name “DENACOL (registered trademark)” series), manufactured by Shin-Nakamura Chemical Co., Ltd. (trade name “NK Ester” series), manufactured by DIC Corporation (trade name “UNIDIC (registered trademark)” series), manufactured by TOAGOSEI CO., LTD. (trade name “Aronix (registered trademark)” series), manufactured by NOF Corporation (trade name “BLEMMER (registered trademark)” series), manufactured by Nippon Kayaku Co., Ltd. (trade name “KAYARAD (registered trademark)” series), manufactured by Kyoeisha Chemical Co., Ltd. (trade name “LIGHT ESTER” series and “LIGHT ACRYLATE” series).

More specifically, for example, a resin which is cured by irradiation with electron beams or ultraviolet rays, a thermosetting resin, or the like may be used. In particular, a thermosetting silicone type HC layer formed by a partially hydrolyzed oligomer of an alkoxysilane compound, a HC layer formed by a thermosetting polysiloxane resin, an ultraviolet curing acrylic HC layer formed by an acrylic compound having an unsaturated group, or a thermosetting inorganic material is preferable. In addition, examples of a material which can be used for the transparent HC layer may include an acrylic resin containing aqueous colloidal silica (JP 2005-66824 A), a polyurethane resin composition (JP 2005-110918 A), a resin membrane using an aqueous silicone compound as a binder (JP 2004-142161 A), an organic/inorganic polysilazane membrane, and a membrane using a hydrophilicity-accelerating agent (AZ Electronic Materials Ltd.) in organic/inorganic polysilazane.

For the thermosetting silicone type transparent HC layer, a partially hydrolyzed oligomer of an alkoxysilane compound synthesized by a known method can be used.

For the ultraviolet curing acrylic HC layer, as the acrylic compound having an unsaturated group, for example, it is possible to use a polyfunctional (meth)acrylate mixture such as pentaerythritol di(meth)acrylate, diethylene glycol di(meth)acrylate, trimethylol propane tri(meth)acrylate, or tetramethylol tetra(meth)acrylate, and a photopolymerization initiator such as benzoin, benzoin methyl ether, or benzophenone is blended therewith and used. Then, this resultant material is applied to the light entrance side of the acrylic layer and then is cured by ultraviolet rays to thereby form a transparent HC layer.

Further, it is preferable that the transparent HC layer is subjected to a surface treatment to impart hydrophilicity. For example, there can be mentioned corona treatment (JP 11-172028A), plasma surface treatment, ultraviolet/ozone treatment, surface protrusion formation (JP 2009-226613 A), surface micro-processing treatment, and the like.

As a production method of the transparent HC layer, a conventionally known coating method such as a gravure coating method, a reverse coating method, or a die coating method can be used.

Further, regarding the transparent HC layer, for example, it is possible to employ a “layer of preventing dirt from being attached” described in Paragraph [0105] and a “blemish prevention layer” described in Paragraphs [0110] to [0113] of JP 2012-137579 A which are well-known. Moreover, it is also possible to employ layers described in Paragraphs [0015] to [0031] of JP 2011-128501 A.

Further, as a particularly preferred example of the transparent HC layer, an HC layer containing a polyfunctional acrylic monomer and a silicone resin can also be used. Regarding the details thereof, the present applicant has already conducted a large number of patent applications and most of the patent applications have been published. Thus, regarding the details thereof, the HC layer can be produced while the publications of the present applicant, which are already known, are suitably referred to.

Further, the transparent HC layer may contain an ultraviolet absorbing agent or an antioxidant. As an ultraviolet absorbing agent or an antioxidant, an ultraviolet absorbing agent or an antioxidant can be used.

The transparent HC layer, particularly, the HC layer containing a polyfunctional acrylic monomer and a silicone resin preferably contains an initiator for initiating polymerization. A photopolymerization initiator of a resin cured by active energy rays such as ultraviolet rays is preferably used. For example, there can be mentioned benzoin and a derivative thereof, acetophenone, benzophenone, hydroxybenzophenone, Michler's ketone, α-amyloxym ester, thioxanthone, and derivatives thereof. In addition, an initiator may be used together with a photosensitizer. The initiator described above can be used as a photosensitizer. Further, when an epoxy acrylate-based initiator is used, sensitizers such as n-butylamine, triethylamine, and tri-n-butylphosphine can be used. The use amount of the initiator or photosensitizer is 0.1 to 15 parts by mass and preferably 1 to 10 parts by mass with respect to 100 parts by mass of a material for forming the transparent HC layer containing a polyfunctional acrylic monomer and a silicone resin. Two or more kinds of initiator can be used in combination, and particularly, in the case of a radical initiator, using two or more kinds of the initiator means that at least two kinds of initiator, preferably radical initiators absorbing different wavelengths from each other are used. More preferably, using two or more kinds of the initiator means that two kinds of initiator having different ultraviolet absorbing wavelengths from each other are used.

In the transparent HC layer, various kinds of additives can be further blended as necessary. For example, a surfactant, a leveling agent, an antistatic agent, and the like can be used.

The leveling agent is effective to reduce surface irregularities. Preferred examples of the leveling agent include silicone leveling agents such as dimethyl polysiloxane-polyoxy alkylene copolymers (for example, SH190 manufactured by Dow Corning Toray Co., Ltd.).

(Substrate)

A substrate which is used in the light reflective film as necessary is not particularly limited as long as it is formed by a transparent organic material.

Examples of such a substrate include a film formed by a resin such as methacrylic acid ester, polyethylene terephthalate (PET), polyethylene naphthalate (PEN), polycarbonate (PC), polyarylate, polystyrene, aromatic polyamide, polyether ether ketone, polysulfone, polyether sulfone, polyimide, or polyether imide, and further a resin film or the like formed by laminating the above resin into two or more layers. Among them, PET, PEN, PC, or the like is preferably used.

The thickness of the substrate is preferably 5 to 200 μm and more preferably 15 to 150 μm. Those formed by laminating two or more substrates may be used, and at this time, the types of substrate may be the same as or different from each other.

Further, the transmittance in a visible light region indicated by JIS R3106-1998 of the substrate is preferably 85% or more and particularly preferably 90% or more.

Further, the substrate using the resin or the like described above may be an unstretched film or a stretched film. From the viewpoint of improving strength and suppressing thermal expansion, a stretched film is preferable.

The substrate can be produced by a general method known in the related art. For example, it is possible to produce an unstretched substrate that is substantially amorphous and not oriented by melting a resin to be a material by an extruder, extruding by a circular die or T-die, and quenching. In addition, it is possible to produce a stretched substrate by stretching the unstretched substrate in the flow (vertical axis) direction of the substrate or the direction (horizontal axis) perpendicular to the flow direction of the substrate by a known method such as uniaxial stretching, tenter-type sequential biaxial stretching, tenter-type simultaneous biaxial stretching, or tubular-type simultaneous biaxial stretching.

Further, a relaxation treatment and an off-line heat treatment may be carried out on a substrate from the viewpoint of size stability. The relaxation treatment is preferably carried out in a tenter for horizontal stretching after thermally fixing during a stretching and film formation step of the above-described polyester film, or in a step from leaving the tenter until winding-up. The relaxation treatment is performed preferably at a treatment temperature of 80 to 200° C. and more preferably at a treatment temperature of 100 to 180° C. The relaxation treatment is also performed preferably at a relaxation ratio in a range from 0.1 to 10% in both of the longitudinal direction and the width direction, and more preferably at a relaxation ratio of 2 to 6%.

It is preferable to coat one side or both sides of a substrate with an undercoat layer coating solution inlinely in a film formation process. In the present invention, undercoat application during a film formation step is referred to as inline undercoat. Examples of a resin used in an undercoat layer coating solution include a polyester resin, an acrylic modified polyester resin, a polyurethane resin, an acrylic resin, a vinyl resin, a vinylidene chloride resin, a polyethylene iminevinylidene resin, a polyethyleneimine resin, a polyvinyl alcohol resin, a modified polyvinyl alcohol resin, and gelatin. Conventionally known additives can also be added to these undercoat layers. Coating of the above-described undercoat layer can be performed in a known method such as roll coat, gravure coat, knife coat, dip coat, or spray coat. The coating amount of the undercoat layer is preferably about 0.01 to 2 g/m² (dry state).

[Method of Producing Light Reflective Membrane]

There is no particular limitation on the method of producing a light reflective membrane, and any methods can be used as long as a light reflective membrane which has a reflection unit configured by a high refractive index layer and a low refractive index layer can be formed. Regarding the details thereof, the present applicant has already conducted a large number of patent applications and most of the patent applications have been published. Thus, regarding the details thereof, the light reflective membrane can be produced while the publications of the present applicant, which are already known, are suitably referred to.

[Light Reflector]

The light reflective film wound off from the light reflective film roll can be applied to a wide range of fields. For example, the light reflective film is attached to facility exposed to sunlight for a long time such as outside windows in buildings and automobile windows, and used for the purpose of mainly enhancing weather resistance as a film for window attachment such as an infrared light reflective film (near-infrared light reflective film) that imparts an effect of infrared reflection, a film for an agricultural plastic green house, and the like.

In particular, the light reflective film wound off from the light reflective film roll is favorable for a member which is attached through a pressure sensitive adhesive layer to a base body such as glass or a glass substitute resin.

According to another embodiment of the present invention, a light reflector is provided in which the light reflective film wound off from the light reflective film roll is provided on at least one surface of the base body.

Specific examples of the base body include glass, a polycarbonate resin, a polysulfone resin, an acrylic resin, a polyolefin resin, a polyether resin, a polyester resin, a polyamide resin, a polysulfide resin, an unsaturated polyester resin, an epoxy resin, a melamine resin, a phenol resin, a diallyl phthalate resin, a polyimide resin, an urethane resin, a polyvinyl acetate resin, a polyvinyl alcohol resin, a styrene resin, a vinyl chloride resin, a metal plate, and ceramic. The kind of resin may be any of a thermoplastic resin, a thermosetting resin, and an ionizing radiation curable resin, and two or more kinds of these may be used in combination. The base body which may be used in the present invention can be produced by a known method such as extrusion molding, calendar molding, injection molding, hollow molding, or compression molding. The thickness of the base body is not particularly limited, but is usually 0.1 mm to 5 cm.

[Light Reflective Film Roll Package 21]

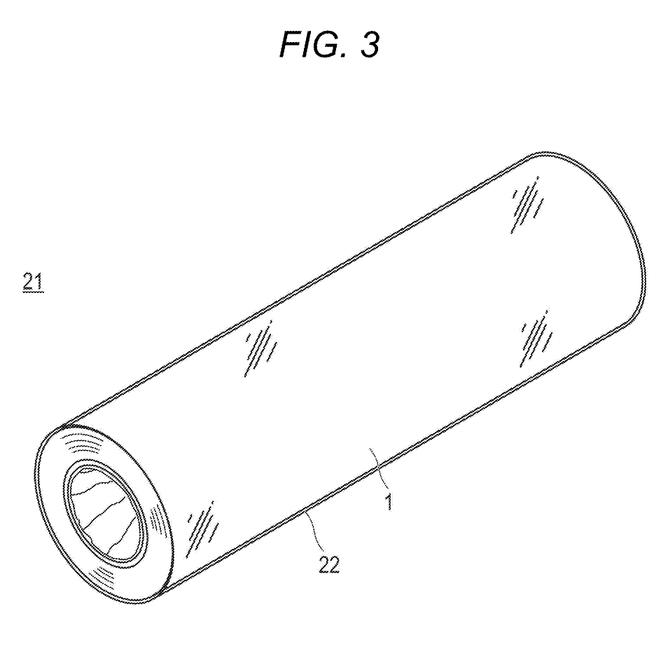

FIG. 3 is a schematic perspective view illustrating the basic configuration of a light reflective film roll package 21 used in an embodiment of the present invention.

As illustrated in FIG. 3, the light reflective film roll package 21 of the present invention is characterized in that the light reflective film roll 1 is put into a tubular bag 22. When the package form in which the light reflective film roll 1 is put into the tubular bag 22 in this way is employed, it is excellent in that the light reflective film roll package 21, which can prevent troubles caused by the winding misalignment between the surface (the surface of the outermost layer) of the HC layer 19 at the winding finish end portion of the light reflective film and the package sheet to be wound up in the cylindrical (roll winding) direction, can be provided. Specifically, in the light reflective film roll package of the related art, the light reflective film roll 1′ of the related art is packaged by the package sheet of the related art to be wound up in the cylindrical (roll winding) direction and the center portion in the width direction of the winding finish end portion of the light reflective film is taped by a tape for temporary taping. For this reason, troubles caused by winding misalignment (for example, scratches or fine unevenness on the surface of the light reflective film roll 1′, and folding and bending, turning-up, or loosening of the winding finish end portion of the light reflective film of the light reflective film roll 1′) occur when the package sheet is wound up. In this regard, in the present invention, by employing the package form in which the light reflective film roll 1 is put into the tubular bag 22, a gap is generated between the light reflective film roll 1 and the tubular bag 22 and a contact face between the HC layer 19 of the surface of the light reflective film roll 1 and the tubular bag 22 is decreased. As a result, it is possible to prevent troubles caused by winding misalignment by the package sheet as in the related art (since winding-up is performed in the same direction, if misalignment occurs in this direction, scratches occur). Furthermore, by using the light reflective film roll 1, which has the configuration that can prevent folding and bending, turning-up, or loosening of the winding finish end portion of the light reflective film as described above, it is also excellent in that folding and bending, turning-up, or loosening does not occur in the winding finish end portion of the light reflective film of the light reflective film roll 1 and protection by the tubular bag 22 is favorably maintained at the time of putting the film roll into the tubular bag 22 or at the time of handling after that.

Incidentally, similarly to the light reflective film roll package of the related art, the end portion at the opening side of the light reflective film roll package 21 (that is, the end portion at the opening side of the tubular bag 22) is stored in such a manner that the redundant end portion at the opening side of the tubular bag 22 is woven toward the inner side in the cylinder of the core main body 11 of the light reflective film roll 1. Further, if necessary, this redundant portion may be temporarily taped by a tape after the storage.

(Material of Tubular Bag 22)

The material of the tubular bag 22 is not particularly limited, and the same material as a packaging sheet of the related art can be used. Specifically, polyethylene or the like can be used, but the material is not limited thereto.

(Shape of Tubular Bag 22)

The shape of the tubular bag 22 may be a shape in which one end portion of the cylindrical shape is closed, the other end portion is opened, and the length of the cylindrical portion in the width direction is larger than the length L of the light reflective film roll in the width direction. The opening end portion, which protrudes from the light reflective film roll 1, of the tubular bag 22 may be pushed into the inner side of the cylinder of the core main body 11 of the light reflective film roll 1 and stored. Incidentally, the light reflective film roll 1 is stored in the inner portion of the tubular bag by using both end of the tubular bag as opening portions, and then both the protruding ends of the tubular bag may also be pushed into the inner side of the cylinder of the core main body 11 of the light reflective film roll 1 and stored.

(Size of Cylindrical Diameter of Tubular Bag 22)

The size of the cylindrical diameter of the tubular bag 22 may be larger than the outer diameter of the light reflective film roll 1 such that the light reflective film roll 1 is easily inserted in the tubular bag 22, and the above-described effect, particularly, the contact face between the HC layer on the surface of the light reflective film roll 1 and the tubular bag 22 is decreased.

### EXAMPLES

Hereinafter, the present invention will be described in detail with reference to Examples; however, the present invention is not limited thereto. Incidentally, the term “part” or “%” in Examples represents “part by mass” or “% by mass” unless otherwise specified.

### Example 1

### Preparation of Coating Liquid for Low Refractive Index Layer

First, a coating liquid for a low refractive index layer was prepared. Specifically, 400 parts of colloidal silica (10% by mass) (SNOWTEX OXS; manufactured by NISSAN CHEMICAL INDUSTRIES, LTD.), 50 parts of aqueous solution of boric acid (30% by mass), 300 parts of polyvinyl alcohol (4% by mass) (JP-45; polymerization degree: 4500, saponification degree: 88% by mol; manufactured by JAPAN VAM & POVAL CO., LTD.), and 3 parts of surfactant (5% by mass) (Softazoline LSB-R; manufactured by Kawaken Fine Chemicals Co., Ltd.) were added at 45° C. in this order. Then, by finishing with 100 parts with pure water, a coating liquid for a low refractive index layer was prepared.

<<Preparation of Coating Liquid for High Refractive Index Layer>>

Next, a coating liquid for a high refractive index layer was prepared. Specifically, a dispersion liquid of silica-modified titanium oxide particles was prepared in advance. A solvent or the like was added thereto.

The dispersion liquid of silica-modified titanium oxide particles was prepared as follows.

A titanium oxide hydrate was obtained by thermal hydrolysis of an aqueous solution of titanium sulfate according to a known method. Water was suspended in the obtained titanium oxide hydrate to obtain 10 L of aqueous suspension (TiO₂ concentration: 100 g/L). 30 L of aqueous solution of sodium hydroxide (concentration: 10 mol/L) was added thereto under stirring, and the resultant mixture was heated to 90° C. and aged for 5 hours. The obtained solution was neutralized with hydrochloric acid, filtered and then washed to thereby obtain a base-treated titanium compound.

Then, the base-treated titanium compound was suspended in pure water so as to have a TiO₂ concentration of 20 g/L. 0.4% by mol of citric acid with respect to the amount of TiO₂ was added thereto under stirring. The resultant mixture was heated up to 95° C., and concentrated hydrochloric acid was added thereto so as to have a hydrochloric acid concentration of 30 g/L, followed by stirring for 3 hours while maintaining the temperature of the solution. Herein, the obtained mixed solution was subjected to measurement of pH and zeta potential. As a result, the pH thereof was 1.4 and the zeta potential thereof was +40 mV. Further, the particle diameter measurement was performed by Zetasizer Nano (manufactured by Malvern Instruments Ltd.). As a result, the volume average particle diameter was 35 nm and the monodispersity was 16%.

10.0% by mass of aqueous dispersion liquid of titanium oxide sol was prepared by adding 1 kg of pure water to 1 kg of 20.0% by mass of aqueous dispersion liquid of titanium oxide sol containing rutile type titanium oxide particles.

After 2 kg of pure water was added to 0.5 kg of 10.0% by mass of aqueous dispersion liquid of titanium oxide sol described above, the resultant mixture was heated to 90° C. Thereafter, 1.3 kg of aqueous silicic acid solution having a SiO₂ concentration of 2.0% by mass was gradually added thereto. The obtained dispersion liquid was subjected to a heating treatment at 175° C. for 18 hours in an autoclave for further concentration to thereby obtain a dispersion liquid (sol aqueous dispersion liquid) of 20% by mass of silica-modified titanium oxide particles in which titanium oxide coated with SiO₂ having a rutile type structure was contained.

A coating liquid for a high refractive index layer was prepared by adding a solvent or the like to the sol aqueous dispersion liquid of silica-modified titanium oxide particles prepared in this way. Specifically, 300 parts of sol aqueous dispersion liquid of silica-modified titanium oxide particles (20.0% by mass), 20 parts of polyvinyl alcohol (10% by mass) (PVA103, polymerization degree: 300, saponification degree: 99% by mol; manufactured by KURARAY CO., LTD.), 100 parts of aqueous solution of boric acid (3% by mass), 350 parts of polyvinyl alcohol (4% by mass) (PVA-124, polymerization degree: 2400, saponification degree: 88% by mol; manufactured by KURARAY CO., LTD.), and 1 part of surfactant (5% by mass) (Softazoline LSB-R; manufactured by Kawaken Fine Chemicals Co., Ltd.) were added at 45° C. in this order. Then, by finishing with 100 parts with pure water, a coating liquid for a high refractive index layer was prepared.

<<Production of Light Reflective Film Roll>>

By using a slide hopper coating apparatus and maintaining the temperatures of the coating liquid for a low refractive index layer and the coating liquid for a high refractive index layer, which were obtained from the above, at 45° C., 18 layers were formed by simultaneous multilayer coating on a substrate (a polyethylene terephthalate film having a thickness of 50 μm; manufactured by Toyobo Co., Ltd., A4300), which has been heated to 45° C. At this time, the bottom layer and the top layer were set to a low refractive index layer while other layers were set such that the low refractive index layer and the high refractive index layer were alternately laminated. Regarding the coating amount, a light reflective membrane was formed on the substrate such that the thickness of each low refractive index layer was adjusted to 150 nm and the thickness of each high refractive index layer was adjusted to 120 nm at the time of drying.

(Formation of Pressure Sensitive Adhesive Layer)

A coating liquid for a pressure sensitive adhesive layer was produced by the following formulation.

TABLE 1

| Composition of coating liquid for | |
|---|---|
| pressure sensitive adhesive layer | Blending amount |
| Acrylic pressure sensitive adhesive | 100 parts |
| (N-2147; manufactured by The Nippon | (concentration: 35%) |
| Synthetic Chemical Industry Co., Ltd.) | |
| Ethyl acetate | 121.6 parts |
| UV absorbing agent | 3.15 parts |
| (T-477; manufactured by BASF) | (concentration: 80%) |
| Silane coupling agent | 0.90 parts |
| (KBM403; manufactured by Shin-Etsu | (concentration: 10%) |
| Chemical Co., Ltd.) | |
| Isocyanate-based cross-linking agent | 5 parts |
| (COLONATE L55E; Nippon | (concentration: 55%) |
| Polyurethane Industry Co., Ltd.) | |

The coating liquid for a pressure sensitive adhesive layer was applied to a silicon surface of separator SP-PET (brand: PET-O2-BU; manufactured by Mitsui Chemicals Tohcello, Inc.) with a comma coater so as to have a dried membrane thickness of 10 μm, dried at 80° C. for 1 minute, and a substrate film having the above-produced light reflective membrane formed thereon was supplied to be laminated with one outermost layer of the light reflective membrane, thereby forming a pressure sensitive adhesive layer on one outermost layer of the light reflective membrane.

(Formation of Hard Coat Layer)

ATO (trade name: SR35M; manufactured by ANP) was used as an infrared absorbing agent, BEAMSET 577 (manufactured by ARAKAWA CHEMICAL INDUSTRIES, LTD.) was used as an ultraviolet curable resin, and methyl ethyl ketone was added as a solvent. Further, 0.08% by mass of fluorine-based surfactant (trade name: Ftergent (registered trademark) 650A, manufactured by NEOS COMPANY LIMITED) was added such that the total solid content became 40 parts by mass and the added amount of ATO became 55% by mass with respect to the total solid content, thereby preparing a coating liquid for a hard coat layer.

Of the light reflective film in which the light reflective membrane produced above was formed, the prepared coating liquid for a hard coat layer was applied to an outermost layer opposite to the layer, on which the pressure sensitive adhesive was formed, of the light reflective membrane with a gravure coater under the condition of having a dried membrane thickness of 5 μm, then dried at a drying section temperature of 90° C. for 1 minute, and the hard coat layer was cured using an ultraviolet lamp under the condition including an illuminance of the irradiation unit of 100 mW/cm and an irradiation amount of 0.5 J/cm² to form the hard coat layer, thereby forming a near-infrared light reflective film.

<<Production of Film Roll Package>>

The drying of the near-infrared light reflective film having the pressure sensitive adhesive formed on one surface of the light reflective membrane and the hard coat layer formed on the opposite outermost layer was ended while the near-infrared light reflective film was conveyed with a plurality of rolls, and the near-infrared light reflective film was wound up on the cushion core (core main body: a paper cylindrical body (3-inch core) having a length in the width direction of 1.5 m, thickness of core main body; paper 4 mm+cushion layer thickness; 2 mm), thereby obtaining a light reflective film roll having a film thickness of 100 μm, a length (width) in the width direction of 1.5 m, and a length of 2000 m. At this time, at the end of winding up the light reflective film, the center portion in the width direction (the position of the symbol C in FIG. 1C) of the winding finish end portion of the light reflective film was taped at one position by an adhesion tape (a paper tape for temporary taping or a sealing material, tape width: 2 cm, length: 4 cm) to thereby obtain a light reflective film roll.

The obtained light reflective film roll was packaged with a polyethylene film as a package, and the center portion in the width direction of the winding finish end portion of the packaging film was taped at one position by an adhesion tape (a paper tape for temporary taping or a sealing material, tape width: 2 cm, length: 4 cm), thereby producing a light reflective film roll package 1.

### Example 2

A light reflective film roll package 2 was obtained in the same manner as in Example 1, except that, in Example 1, the winding start end portion of the near-infrared light reflective film of the light reflective film roll was fixed to the cushion core by a cushion tape serving as the cushion member.

Herein, the cushion core (=the cushion layer) and the cushion tape were arranged such that the length of the cushion core in the width direction and the length of the cushion tape serving as the cushion member in the width direction became the same length (the symbol L in the drawing) (see FIG. 2A).

### Example 3

A light reflective film roll package 3 was obtained in the same manner as in Example 2, except that, in Example 2, at the end of winding up the light reflective film, the winding finish end portion in the width direction of the light reflective film was taped at two positions by an adhesion tape (a paper tape for temporary taping or a sealing material, tape width: 2 cm, length: 4 cm) to thereby obtain a light reflective film roll, and after the obtained light reflective film roll was packaged with a polyethylene film as a package, two positions were further taped by an adhesion tape.

Herein, regarding the positions of the adhesion tapes from the end portions in the width direction of the light reflective film roll, in the adhesion tape at one position (the symbol 20a in FIG. 1A), the center position (the length represented by the symbol L₁ in FIG. 1A) of the tape width from the left end portion in the width direction (the symbol B₁ in FIG. 1A) of the light reflective film roll was 20 cm, and in the adhesion tape at the other position (the symbol 20b in FIG. 1A), the center position (the length represented by the symbol L₂ in FIG. 1A) of the tape width from the right end portion in the width direction (the symbol B₂ in FIG. 1A) of the light reflective film roll was 20 cm. That is, the positions of the tapes from the end portions in the width direction of the light reflective film roll were arranged such that the right portion and the left portion were each disposed at the position of about 13% with respect to the length of the light reflective film roll in the width direction.

Further, regarding the positions of the adhesion tapes from the winding finish end portions of the packaging film in the film roll package, in the adhesion tape at one position, the position (the center position of the tape width) from the left winding finish end portion of the packaging film was 20 cm, and in the adhesion tape at the other position, the position (the center position of the tape width) from the right winding finish end portion of the packaging film was 20 cm. That is, the positions of the adhesion tapes at two positions in the light reflective film roll at which the winding finish end portions in the width direction of the light reflective film were taped and the positions of the adhesion tapes at two positions in the film roll package at which the winding finish end portions in the width direction of the packaging film were taped indicate that the same positions at both right and left sides (positions vertically overlapping via the packaging film) are taped.

### Example 4

A light reflective film roll package 4 was obtained in the same manner as in Example 3, except that, in Example 3, the light reflective film roll was put into a tubular polyethylene bag instead of a polyethylene film and packaged when the light reflective film roll was packaged.

### Comparative Example 1

A light reflective film roll package 5 was obtained in the same manner as in Example 1, except that, in Example 1, a paper core (core main body: configured only by a cylindrical paper body having a width of 1.5 m and a 3-inch core having a thickness of 6 mm (outer diameter: about 7.62 mm)) was used instead of the cushion core.

### Comparative Example 2

A light reflective film roll package 6 was obtained in the same manner as in Comparative Example 1, except that, in Comparative Example 1, when the light reflective film was fixed to a paper core, the light reflective film was attached to the paper core by the same cushion tape as the cushion tape used in Example 2.

<<Evaluation Item>>

(Measurement of Visible Light Transmittance (VLT) and Total Solar Energy Rejected Rate (TSER))

By using a spectrophotometer (using an integrating sphere, manufactured by Hitachi, Ltd., U-4000 Type), a visible light transmittance of the light reflective film sample, which was wound off from each light reflective film roll taken out from the light reflective film roll packages 1 to 6 that were formed by winding up the light reflective film with a tension in Examples 1 to 4 and Comparative Examples 1 and 2, in a region of 300 nm to 2000 nm was measured, and the total solar energy rejected rate (TSER) was calculated from the solar transmittance and the solar absorptivity. The obtained results are presented in Table 2.

(Sunlight Unevenness)

The light reflective film sample, which was wound off from each light reflective film roll taken out from the light reflective film roll packages 1 to 6 of Examples 1 to 4 and Comparative Examples 1 and 2, was visually observed with a fluorescent lamp and sunlight and evaluation was performed as follows. The evaluation results are presented in Table 2.

⊙: There is no problem even at the time of viewing with sunlight.

◯: There is no problem in observation with a fluorescent lamp, but small unevenness is slightly observed at the time of viewing with sunlight.

Δ: There is no problem in observation with a fluorescent lamp, but unevenness is recognized at the time of viewing with sunlight.

x: Slight unevenness is observed even with a fluorescent lamp and unevenness is clearly recognized at the time of viewing with sunlight.

(Applicability)

The light reflective film sample, which was wound off from each light reflective film roll taken out from the light reflective film roll packages 1 to 6 of Examples 1 to 4 and Comparative Examples 1 and 2, was applied to the rear window of the automobile. The application state at this time was evaluated as follows. The evaluation results are presented in Table 2.

◯: Application can be performed without any problem.

Δ: A part of the end portion is curled at the time of positioning of the film and it takes time to perform application.

x: After the attachment (after the application), the end portion is curled and floats.

(Trouble of Surface of Light Reflective Film Roll)

The light reflective film sample, which was wound off from each light reflective film roll taken out from the light reflective film roll packages 1 to 6 of Examples 1 to 4 and Comparative Examples 1 and 2, of the surface (outermost peripheral) portion of each light reflective film roll was visually evaluated. The evaluation results are presented in Table 2.

◯: There is no trouble caused by winding misalignment between the light reflective film roll and the packaging film or the tubular bag.

Δ: The trouble caused by winding misalignment is slightly and partially observed between the light reflective film roll and the packaging film or the tubular bag.

x: The trouble caused by winding misalignment is clearly and entirely observed between the light reflective film roll and the packaging film or the tubular bag.

TABLE 2

| | Main | | | | | |
|---|---|---|---|---|---|---|
| | configuration | | | | | |
| | of light | | | | | |
| | reflective | | | Sunlight | | |
| | film roll | VLT | TSER | uneven- | Applica- | |
| | package | (%) | (%) | ness | bility | Trouble |
| Example 1 | Cushion core | 70 | 46 | ∘ | Δ | Δ |
| | (=(1)) | | | | | |
| Example 2 | (1) + cushion | 71 | 47 | ⊙ | Δ | Δ |
| | tape (=(2)) | | | | | |
| Example 3 | (1) + (2) + | 70 | 46 | ⊙ | ∘ | Δ |
| | taping light | | | | | |
| | reflection | | | | | |
| | film roll at | | | | | |
| | two positions | | | | | |
| | in width | | | | | |
| | direction | | | | | |
| | with tape for | | | | | |
| | fixing end | | | | | |
| | portion | | | | | |
| | (=(3)) | | | | | |
| Example 4 | (1) + (2) + | 72 | 48 | ⊙ | ∘ | ∘ |
| | (3) + tubular | | | | | |
| | bag | | | | | |
| Comparative | Paper core | 69 | 45 | x | x | x |
| Example 1 | | | | | | |
| Comparative | Paper core + | 70 | 45 | Δ | x | x |
| Example 2 | cushion tape | | | | | |

The present application is based on Japanese Patent Application No. 2014-085798 filed on Apr. 17, 2014, the disclosed contents of which are incorporated in their entirety by reference.

### REFERENCE SIGNS LIST

1 LIGHT REFLECTIVE FILM ROLL OF PRESENT INVENTION
1′ LIGHT REFLECTIVE FILM ROLL OF RELATED ART
11 CORE MAIN BODY
12 CUSHION LAYER
13 CUSHION MEMBER
14 CUSHION CORE
15 LIGHT REFLECTIVE FILM
20a, 20b, 20c TAPE (TAPE FOR TEMPORARY TAPING)
21 LIGHT REFLECTIVE FILM ROLL PACKAGE
22 TUBULAR BAG
A WINDING START END PORTION (WINDING-UP END) OF LIGHT REFLECTIVE FILM
B WINDING FINISH END PORTION OF LIGHT REFLECTIVE FILM
B₁ CORNER PORTION (LEFT END PORTION) AT FURTHER LEFT SIDE OF WINDING FINISH END PORTION OF LIGHT REFLECTIVE FILM
B₂ CORNER PORTION (RIGHT END PORTION) AT FURTHER RIGHT SIDE OF WINDING FINISH END PORTION OF LIGHT REFLECTIVE FILM
C CENTER (CENTER PORTION) OF WINDING FINISH END PORTION OF LIGHT REFLECTIVE FILM
c GAP
d LENGTH ALONG CYLINDRICAL SHAPE OF CUSHION MEMBER
F FORCE APPLIED TO LIGHT REFLECTIVE MEMBRANE OF WINDING START END PORTION OF LIGHT REFLECTIVE FILM OR IN VICINITY THEREOF
L LENGTH OF CORE MAIN BODY IN WIDTH DIRECTION (ROLL WIDTH)
L₁ DISTANCE FROM LEFT END PORTION B₁ TO CENTER POSITION OF WIDTH OF TAPE 20a
L₂ DISTANCE FROM RIGHT END PORTION B₂ TO CENTER POSITION OF WIDTH OF TAPE 20b
L₃ LENGTH OF HALF OF CORE MAIN BODY IN WIDTH DIRECTION (=LENGTH FROM END PORTION IN WIDTH DIRECTION OF CORE MAIN BODY TO CENTER PORTION)
W TURNING-UP OF END PORTION

1. A light reflective film roll comprising:
a core main body formed in a cylindrical shape and having a length in a width direction of 1.2 m or more;
a cushion layer formed by a foamed resin and provided on an outer surface of the core main body; and
a light reflective film including a light reflective membrane, which has a reflection unit formed by alternately laminating a high refractive index layer and a low refractive index layer, a pressure sensitive adhesive layer at one outermost layer of the light reflective membrane, and a hard coat layer at the other outermost layer of the light reflective membrane,
wherein the light reflective film is wound up on the outer surface of the cushion layer.

2. The light reflective film roll according to claim 1, wherein an end portion at which the light reflective film is started to be wound up is attached to the cushion layer provided on the core main body by a cushion member.

3. The light reflective film roll according to claim 1, wherein a winding finish end portion of the light reflective film is taped by a tape at least two positions and the tape positions closest to right and left end portions in the width direction of the light reflective film roll satisfy the following formula:
(Tape position from end portion in width direction of light reflective film roll/length of light reflective film roll in width direction)×100=0.5 to 25% [Mathematical Formula 1]
wherein, regarding the tape position from the end portion in the width direction of the light reflective film roll, the position of the tape closest to the left end portion in the width direction is designated as the tape position from the left end portion, the position of the tape closest to the right end portion in the width direction is designated as the tape position from the right end portion, each tape position satisfies the above requirement, and the tape position is designated as the center portion of the tape width.

4. A light reflective film roll package comprising the light reflective film roll according to claim 1 in a tubular bag.

5. The light reflective film roll according to claim 2, wherein a winding finish end portion of the light reflective film is taped by a tape at least two positions and the tape positions closest to right and left end portions in the width direction of the light reflective film roll satisfy the following formula:
(Tape position from end portion in width direction of light reflective film roll/length of light reflective film roll in width direction)×100=0.5 to 25% [Mathematical Formula 1]
wherein, regarding the tape position from the end portion in the width direction of the light reflective film roll, the position of the tape closest to the left end portion in the width direction is designated as the tape position from the left end portion, the position of the tape closest to the right end portion in the width direction is designated as the tape position from the right end portion, each tape position satisfies the above requirement, and the tape position is designated as the center portion of the tape width.

6. A light reflective film roll package comprising the light reflective film roll according to claim 2 in a tubular bag.

7. A light reflective film roll package comprising the light reflective film roll according to claim 3 in a tubular bag.
